(19) United States
(12) Patent Application Publication
(10) Pub. No.: US 2023/0033614 A1
(43) Pub. Date: Feb. 2, 2023

(54) ACTIVE ENERGY RAY-CURABLE INK AND IMAGE RECORDING METHOD

(71) Applicant: FUJIFILM Corporation, Tokyo (JP)

(72) Inventor: Kenjiro ARAKI, Kanagawa (JP)

(73) Assignee: FUJIFILM Corporation, Tokyo (JP)

(21) Appl. No.: 17/944,137

(22) Filed: Sep. 13, 2022

Related U.S. Application Data
(63) Continuation of application No. PCT/JP2021/010581, filed on Mar. 16, 2021.

(30) Foreign Application Priority Data
Mar. 26, 2020 (JP) 2020-056584

(51) Int. Cl. C09D 11/107; C09D 11/38; B41M 7/00

(52) U.S. Cl. CPC C09D 11/107; C09D 11/38; B41M 7/0081

(57) ABSTRACT

An active energy ray-curable ink including a radical polymerizable monomer, inorganic oxide particles, a photoacid generator, and a radical photopolymerization initiator and an image recording method.

### CROSS-REFERENCE TO RELATED APPLICATION

This application is a Continuation of International Application No. PCT/JP2021/010581, filed Mar. 16, 2021, which claims priority to Japanese Patent Application No. 2020-056584, filed Mar. 26, 2020. Each of the above applications is hereby expressly incorporated by reference, in its entirety, into the present application.

### BACKGROUND OF THE INVENTION

### 1. Field of the Invention

The present disclosure relates to an active energy ray-curable ink and an image recording method.

### 2. Description of the Related Art

An image recording method in which an ink is applied to a recording medium and the ink deposited on the recording medium is irradiated with an active energy ray, such as ultraviolet radiation, to cure and form an image is known. An ink used in such an image recording method is referred to as “active energy ray-curable ink” or the like.

For example, JP2006-152064A discloses a high-sensitivity active light-curable ink jet ink that enables the formation of a firm coating film having high flexibility, which is an active light-curable composition that includes a radical polymerizable monomer that serves as a photopolymerizable compound and an inorganic oxide colloid. Another active light-curable ink jet ink having the above-described functions which is disclosed in JP2006-152064A is an active light-curable ink jet ink that includes a compound having an oxetane ring and an epoxy compound that serve as photopolymerizable compounds, a photoacid generator, and an inorganic oxide colloid.

JP2019-157062A discloses an active energy ray-curable composition in which silica particles are unlikely to aggregate and settle, which improves intermittent discharge performance, which reduces the unevenness in the color of a print image, and which forms a coating film having high hardness and excellent abrasion resistance, the active energy ray-curable composition including an inorganic pigment and silica particles, wherein the volume average particle size of the silica particles is 1/10 to ⅓ of that of the inorganic pigment and the surfaces of the silica particles are modified with a (meth)acrylate compound,

### SUMMARY OF THE INVENTION

An image recorded using an active energy ray-curable ink may have a strong gloss. Therefore, for example, such an image may have a relief sense or become conspicuous.

For example, in order to reduce the relief sense of such an image and make the image inconspicuous, an image recorded using an active energy ray-curable ink may be required to have a reduced gloss in terms of image quality.

An object of an aspect of the present disclosure is to provide an active energy ray-curable ink with which an image having a reduced gloss can be recorded and an image recording method in which the active energy ray-curable ink is used.

Specific means for achieving the above object includes the following aspects.

<1> An active energy ray-curable ink including a radical polymerizable monomer, inorganic oxide particles, a photoacid generator, and a radical photopolymerization initiator.

<2> The active energy ray-curable ink described in <1>, wherein the inorganic oxide particles include at least one of silica particles or alumina particles.

<3> The active energy ray-curable ink described in <1> or <2>, wherein the inorganic oxide particles have an average primary particle size of 0.1 to 3.0 μm.

<4> The active energy ray-curable ink described in any one of <1> to <3>, wherein the photoacid generator is a sulfonium salt.

<5> The active energy ray-curable ink described in any one of <1> to <4>, further including a cation photosensitizer.

<6> The active energy ray-curable ink described in <5>, wherein the cation photosensitizer is a compound including an anthracene skeleton.

<7> The active energy ray-curable ink described in <5> or <6>, wherein a content of the cation photosensitizer is from 0.5% by mass to 5.0% by mass with respect to a total amount of the active energy ray-curable ink.

<8> The active energy ray-curable ink described in any one of <1> to <7>, wherein a content of the inorganic oxide particles is from 0.5% by mass to 15.0% by mass with respect to a total amount of the active energy ray-curable ink.

<9> The active energy ray-curable ink described in any one of <1> to <8>, wherein a mass ratio of a content of the inorganic oxide particles to a content of the photoacid generator is from 0.2 to 15.0.

<10> The active energy ray-curable ink described in any one of <1> to <9>, wherein a total content of the inorganic oxide particles and the photoacid generator is from 1.0% by mass to 17.5% by mass with respect to a total amount of the active energy ray-curable ink.

<11> The active energy ray-curable ink described in any one of <1> to <10>, wherein a mass ratio of a total content of the radical polymerizable monomer, the inorganic oxide particles, and the photoacid generator to a content of the radical photopolymerization initiator is from 6.0 to 45.0.

<12> The active energy ray-curable ink described in any one of <1> to <11>, wherein the radical polymerizable monomer includes at least one of a monofunctional radical polymerizable monomer or a difunctional radical polymerizable monomer, and wherein a total content of the monofunctional radical polymerizable monomer and the difunctional radical polymerizable monomer is 50% by mass or more with respect to a total amount of the active energy ray-curable ink.

<13> The active energy ray-curable ink described in any one of <1> to <12>, further including a gelling agent that is at least one selected from the group consisting of an ester compound including a chain alkyl group having 12 or more carbon atoms and a ketone compound including a chain alkyl group having 12 or more carbon atoms.

<14> An image recording method including:

applying the active energy ray-curable ink described in any one of <1> to <13> to a recording medium to atm an ink film; and

an irradiation step of irradiating the ink film with an active energy ray.

<15> The image recording method described in <14>, wherein the irradiating includes irradiating the ink film with the active energy ray in an atmosphere having an oxygen concentration of 5% by volume or less.

According to an aspect of the present disclosure, an active energy ray-curable ink with which an image having a reduced gloss can be recorded and an image recording method in which the active energy ray-curable ink is used may be provided.

### DESCRIPTION OF THE PREFERRED EMBODIMENTS

In the present disclosure, a numerical range expressed using “to” means the range specified by the lower and upper limits described before and after “to”, respectively.

In the present disclosure, in the case where a composition includes a plurality of substances that correspond to a component of the composition, the content of the component in the composition is the total content of the substances in the composition unless otherwise specified.

In the present disclosure, when numerical ranges are described in a stepwise manner, the upper or lower limit of a numerical range may be replaced with the upper or lower limit of another numerical range, respectively, and may also be replaced with the values described in Examples below.

In the present disclosure, the term “step” refers not only to an individual step but also to a step that is not distinguishable from other steps but achieves the intended purpose of the step.

In the present disclosure, a combination of preferable aspects is a more preferable aspect.

In the present disclosure, the term “light” conceptually subsumes active energy rays, such as γ-radiation, β-radiation, an electron beam, ultraviolet radiation, and visible light.

In the present disclosure, ultraviolet radiation may be referred to as “ultraviolet (UV) light”.

In the present disclosure, the concept of the term “(meth)acrylate” includes both acrylate and methacrylate. The concept of the term “(meth)acryloyl group” includes both acryloyl and methacryloyl groups. The concept of the term “(meth)acrylic acid” includes both acrylic acid and methacrylic acid.

In the present disclosure, the term “image” refers to a film formed using an ink. The term “image recording” refers to the formation of an image, that is, a film.

In the present disclosure, the concept of the term “image” includes a solid image.

### Active Energy Ray-Curable Ink

An active energy ray-curable ink according to the present disclosure is an active energy ray-curable ink that includes a radical polymerizable monomer, inorganic oxide particles, a photoacid generator, and a radical photopolymerization initiator.

Hereinafter, the active energy ray-curable ink is also referred to simply as “ink”.

The ink according to the present disclosure enables an image having a reduced gloss to be recorded.

The reasons for which the above-described advantageous effects are produced are presumably that the ink includes the radical polymerizable monomer, the inorganic oxide particles, the photoacid generator, and the radical photopolymerization initiator.

Specifically, the reasons for which the advantageous effects are produced are presumably as follows.

Commonly, an image recording using an active energy ray-curable ink that includes a radical polymerizable monomer and a radical photopolymerization initiator is performed by applying the ink to a recording medium and irradiating the ink deposited on the substrate (hereinafter, this ink is also referred to as “ink film”) with light (i.e., active energy ray; the same applies hereinafter). In this image recording, when the ink film is irradiated with light, radicals are generated in the ink film due to the action of the radical photopolymerization initiator, the radicals cause radical polymerization of the radical polymerizable monomer to occur, and the ink film becomes cured as a result of the radical polymerization of the radical polymerizable monomer. Consequently, an image, which is the cured ink film, is Ruined.

In the case where the ink according to the present disclosure is used for the image recording, when an ink film is irradiated with light, not only radicals are generated in the ink film due to the action of the radical photopolymerization initiator, but also an acid is generated in the ink film due to the action of the photoacid generator. The acid causes the inorganic oxide particles included in the ink film to aggregate with one another to form aggregates. It is considered that these aggregates serve as a matting agent and thereby reduce the gloss of the image.

Specifically, since the surface of the ink film is exposed to oxygen, a region of the ink film which is close to the surface (hereinafter, such a region is also referred to as “surface-side region”) is more susceptible to the inhibition of radical polymerization caused by oxygen than a region of the ink film which is close to a recording medium (hereinafter, such a region is also referred to as “recording medium-side region”). Accordingly, it is considered that, when the ink film has not been completely cured in the thickness direction, the surface-side region of the ink film has not been cured although the recording medium-side region of the ink film has been cured. It is considered that, in this situation, the inorganic oxide particles included in the ink are likely to accumulate at the surface-side region of the ink film and that the inorganic oxide particles accumulated at the surface-side region aggregate with one another to faun aggregates, due to the action of the above-described acid. The aggregates formed in the surface-side region of the ink film may serve as a matting agent with effect as described above and consequently reduce the gloss of the image.

JP2006-152064A discloses an ink that substantially includes a radical polymerizable monomer serving as a photopolymerizable compound, inorganic oxide particles, and a radical photopolymerization initiator (hereinafter, this ink is referred to as “radical polymerizable ink R1”). JP2006-152064A also discloses, in addition to the radical polymerizable ink R1, an ink that includes a compound having an oxetane ring and an epoxy compound, which serve as photopolymerizable compounds, inorganic oxide particles, and a photoacid generator (hereinafter, this ink is referred to as “cation polymerizable ink C1”).

However, JP2006-152064A does not disclose an ink that includes all of the radical polymerizable monomer, the inorganic oxide particles, the photoacid generator, and the radical photopolymerization initiator (i.e., the ink according to the present disclosure).

In the radical polymerizable ink R1, which includes inorganic oxide particles but does not include a photoacid generator, the inorganic oxide particles cannot be aggregated by using the acid. It is considered that, when the inorganic oxide particles do not form aggregates, the inorganic oxide particles do not serve as a matting agent since the average primary particle size of the inorganic oxide particles is small. Thus, it is considered that the radical polymerizable ink R1 does not have a gloss reduction effect comparable to that of the ink according to the present disclosure.

In the cation polymerizable ink C1, which includes inorganic oxide particles but does not include a radical photopolymerization initiator, although an acid is generated upon irradiation with light, the inhibition of radical polymerization cannot occur in the surface-side region of the ink film by oxygen because the ink C1 is a cation polymerizable ink. Accordingly, the effect of the inorganic oxide particles to accumulate at the surface-side region of the ink film to form aggregates is unlikely to be produced. Thus, it is considered that the cation polymerizable ink C1 also does not have a gloss reduction effect comparable to that of the ink according to the present disclosure.

As described above, the ink according to the present disclosure enables an image having a reduced gloss to be recorded.

Therefore, the ink according to the present disclosure enables an image having a gloss close to that of a recording medium to be readily produced.

Thus, the ink according to the present disclosure may reduce the relief sense of the image.

Furthermore, the ink according to the present disclosure may make the image inconspicuous.

Consequently, for example, in the case where an invisible image is recorded using the ink according to the present disclosure, an invisible image having further excellent invisibility may be produced.

Each of the constituents that may be included in the ink according to the present disclosure is described below.

### Radical Polymerizable Monomer

The ink according to the present disclosure includes at least one radical polymerizable monomer.

The radical polymerizable monomer is preferably a compound including an ethylenic unsaturated group.

The ethylenic unsaturated group is preferably a (meth)acryloyl group, a vinyl group, an allyl group, or a styryl group and is more preferably a (meth)acryloyl group or a vinyl group.

The radical polymerizable monomer may include only one ethylenic unsaturated group and may include two or more ethylenic unsaturated groups.

The radical polymerizable monomer may include only one type of an ethylenic unsaturated group and may include two or more types of ethylenic unsaturated groups.

The molecular weight of the radical polymerizable monomer is preferably 280 to 1,500, is more preferably 280 to 1,000, and is further preferably 280 to 800.

The radical polymerizable monomer included in the ink according to the present disclosure may be a monofunctional radical polymerizable monomer, a difunctional radical polymerizable monomer, or a trifunctional or higher functional radical polymerizable monomer. The radical polymerizable monomer included in the ink according to the present disclosure may include two or more types of the above radical polymerizable monomers in combination.

Note that,

the term “monofunctional radical polymerizable monomer” used herein refers to a radical polymerizable monomer including only one ethylenic unsaturated group,

the term “difunctional radical polymerizable monomer” used herein refers to a radical polymerizable monomer including only two ethylenic unsaturated groups, and

the term “trifunctional or higher functional radical polymerizable monomer” used herein refers to a radical polymerizable monomer including three or more ethylenic unsaturated groups.

Hereinafter, monofunctional radical polymerizable monomer, difunctional radical polymerizable monomer, and trifunctional or higher functional radical polymerizable monomer may be referred to as “monofunctional monomer”, “difunctional monomer”, and “trifunctional or higher functional monomer”, respectively.

The radical polymerizable monomer included in the ink according to the present disclosure preferably includes at least one of a monofunctional monomer (i.e., monofunctional radical polymerizable monomer) or a difunctional monomer (i.e., difunctional radical polymerizable monomer) in consideration of reduction in the viscosity of the ink (e.g., when the ink is used as an ink jet ink, the ease with which the ink is discharged from an ink jet head (hereinafter, this property is also referred to simply as “discharge performance”)).

In such a case, the total content of the monofunctional monomer and the difunctional monomer is preferably 40% by mass or more, is more preferably 50% by mass or more, is further preferably 55% by mass or more, and is further preferably 60% by mass or more of the total amount of the ink.

In order to reduce the viscosity of the ink, the content of the radical polymerizable monomer in the ink according to the present disclosure is preferably 50% by mass or more, is more preferably 60% by mass or more, is further preferably 65% by mass or more, and is further preferably 70% by mass or more of the total amount of the ink.

In consideration of the discharge performance of the ink and the abrasion resistance of the image, the radical polymerizable monomer included in the ink according to the present disclosure preferably includes:

at least one of a monofunctional monomer or a difunctional monomer, and

a trifunctional or higher functional monomer (preferably, trifunctional monomer).

In such a case, the total content of the monofunctional monomer, the difunctional monomer, and the trifunctional or higher functional monomer is preferably 50% by mass or more, is more preferably 60% by mass or more, is further preferably 65% by mass or more, and is further preferably 70% by mass or more of the total amount of the ink.

Monofunctional Monomer

Examples of the monofunctional monomer include a monofunctional (meth)acrylate, a monofunctional (meth)acrylamide, a monofunctional aromatic vinyl compound, a monofunctional vinyl ether, and a monofunctional N-vinyl compound.

Examples of the monofunctional (meth)acrylate include methyl (meth)acrylate, ethyl (meth)acrylate, propyl (meth)acrylate, n-butyl (meth)acrylate, hexyl (meth)acrylate, 2-ethylhexyl (meth)acrylate, tert-octyl (meth)acrylate, isoamyl (meth)acrylate, decyl (meth)acrylate, isodecyl (meth)acrylate, lauryl (meth)acrylate, stearyl (meth)acrylate, isostearyl (meth)acrylate, cyclohexyl (meth)acrylate, 4-n-butylcyclohexyl (meth)acrylate, 4-tert-butylcyclohexyl (meth)acrylate, bornyl (meth)acrylate, norbornyl (meth)acrylate, isobornyl (meth)acrylate, adamantyl (meth)acrylate, 2-ethylhexyl diglycol (meth)acrylate, butoxyethyl (meth)acrylate, 2-chloroethyl (meth)acrylate, 4-bromobutyl (meth)acrylate, cyanoethyl (meth)acrylate, benzyl (meth)acrylate, butoxymethyl (meth)acrylate, 3-methoxybutyl (meth)acrylate, 2-(2-methoxyethoxy)ethyl (meth)acrylate, 2-(2-butoxyethoxy)ethyl (meth)acrylate, ethylcarbitol (meth)acrylate, 2,2,2-tetrafluoroethyl (meth)acrylate, 1H,1H,2H,2H-perfluorodecyl (meth)acrylate, 4-butylphenyl (meth)acrylate, phenyl (meth)acrylate, 2,4,5-tetramethylphenyl (meth)acrylate, 4-chlorophenyl (meth)acrylate, 2-phenoxymethyl (meth)acrylate, 2-phenoxyethyl (meth)acrylate, glycidyl (meth)acrylate, glycidyloxybutyl (meth)acrylate, glycidyloxyethyl (meth)acrylate, glycidyloxypropyl (meth)acrylate, tetrahydrofurfuryl (meth)acrylate, 2-hydroxyethyl (meth)acrylate, 3-hydroxypropyl (meth)acrylate, 2-hydroxypropyl (meth)acrylate, 2-hydroxybutyl (meth)acrylate, 3-hydroxybutyl (meth)acrylate, 4-hydroxybutyl (meth)acrylate, cyclic trimethylolpropaneformal (meth)acrylate, phenyl glycidyl ether (meth)acrylate, dimethylaminoethyl (meth)acrylate, diethylaminoethyl (meth)acrylate, dimethylaminopropyl (meth)acrylate, diethylaminopropyl (meth)acrylate, trimethoxysilylpropyl (meth)acrylate, trimethylsilylpropyl (meth)acrylate, polyethylene oxide monomethyl ether (meth)acrylate, polyethylene oxide (meth)acrylate, polyethylene oxide monoalkyl ether (meth)acrylate, dipropylene glycol (meth)acrylate, polypropylene oxide monoalkyl ether (meth)acrylate, 2-methacryloyloxyethyl succinate, 2-methacryloyloxyhexahydrophthalic acid, 2-methacryloyloxyethyl-2-hydroxypropyl phthalate, butoxydiethylene glycol (meth)acrylate, trifluoroethyl (meth)acrylate, perfluorooctyl ethyl (meth)acrylate, 2-hydroxy-3-phenoxypropyl (meth)acrylate, ethylene oxide-modified (hereinafter, referred to as “EO-modified”) phenol (meth)acrylate, EO-modified cresol (meth)acrylate, EO-modified nonylphenol (meth)acrylate, propylene oxide-modified (hereinafter, referred to as “PO-modified”) nonylphenol (meth)acrylate, EO-modified-2-ethylhexyl (meth)acrylate, dicyclopentenyl (meth)acrylate, dicyclopentenyloxyethyl (meth)acrylate, dicyclopentanyl (meth)acrylate, (3-ethyl-3-oxetanylmethyl) (meth)acrylate, and phenoxyethylene glycol (meth)acrylate.

Examples of the monofunctional (meth)acrylamide include (meth)acrylamide, N-methyl (meth)acrylamide, N-ethyl (meth)acrylamide, N-propyl (meth)acrylamide, N-n-butyl (meth)acrylamide, N-t-butyl (meth)acrylamide, N-butoxymethyl (meth)acrylamide, N-isopropyl (meth)acrylamide, N-methylol (meth)acrylamide, N,N-dimethyl (meth)acrylamide, N,N-diethyl (meth)acrylamide, and (meth)acryloyl morpholine.

Examples of the monofunctional aromatic vinyl compound include styrene, dimethylstyrene, trimethylstyrene, isopropylstyrene, chloromethylstyrene, methoxystyrene, acetoxystyrene, chlorostyrene, dichlorostyrene, bromostyrene, vinylbenzoic acid methyl ester, 3-methylstyrene, 4-methylstyrene, 3-ethylstyrene, 4-ethylstyrene, 3-propylstyrene, 4-propylstyrene, 3-butylstyrene, 4-butylstyrene, 3-hexylstyrene, 4-hexylstyrene, 3-octylstyrene, 4-octylstyrene, 3-(2-ethylhexyl)styrene, 4-(2-ethylhexyl)styrene, allylstyrene, isopropenylstyrene, butenylstyrene, octenylstyrene, 4-t-butoxycarbonylstyrene, and 4-t-butoxystyrene.

Examples of the monofunctional vinyl ether include methyl vinyl ether, ethyl vinyl ether, propyl vinyl ether, n-butyl vinyl ether, t-butyl vinyl ether, 2-ethylhexyl vinyl ether, n-nonyl vinyl ether, lauryl vinyl ether, cyclohexyl vinyl ether, cyclohexylmethyl vinyl ether, 4-methylcyclohexylmethyl vinyl ether, benzyl vinyl ether, dicyclopentenyl vinyl ether, 2-dicyclopentenoxyethyl vinyl ether, methoxyethyl vinyl ether, ethoxyethyl vinyl ether, butoxyethyl vinyl ether, methoxyethoxyethyl vinyl ether, ethoxyethoxyethyl vinyl ether, methoxypolyethylene glycol vinyl ether, tetrahydrofurfuryl vinyl ether, 2-hydroxyethyl vinyl ether, 2-hydroxypropyl vinyl ether, 4-hydroxybutyl vinyl ether, 4-hydroxymethylcyclohexylmethyl vinyl ether, diethylene glycol monovinyl ether, polyethylene glycol vinyl ether, chloroethyl vinyl ether, chlorobutyl vinyl ether, chloroethoxyethyl vinyl ether, phenylethyl vinyl ether, and phenoxypolyethylene glycol vinyl ether.

Examples of the monofunctional N-vinyl compound include N-vinylcaprolactam, N-vinylpyrrolidone, N-vinyloxazolidinone, and N-vinyl-5-methyloxazolidinone.

The monofunctional monomer preferably includes at least one of the monofunctional (meth)acrylate or the monofunctional N-vinyl compound and more preferably includes at least one of a monofunctional (meth)acrylate including an alicyclic structure or the monofunctional N-vinyl compound.

The monofunctional (meth)acrylate including an alicyclic structure is preferably isobornyl (meth)acrylate, norbornyl (meth)acrylate, or adamantyl (meth)acrylate and is more preferably isobornyl (meth)acrylate.

The total proportion of the monofunctional (meth)acrylate (preferably, the monofunctional (meth)acrylate including an alicyclic structure) and the monofunctional N-vinyl compound to the monofunctional monomers is preferably 50% to 100% by mass, is more preferably 60% to 100% by mass, and is further preferably 80% to 100% by mass.

The proportion of the monofunctional N-vinyl compound to the monofunctional monomers is preferably 20% by mass or more, is more preferably 30% by mass or more, and is further preferably 50% by mass or more.

Difunctional Monomer

Examples of the difunctional monomer include a difunctional (meth)acrylate, a difunctional vinyl ether, and a difunctional monomer that includes a vinyl ether group and a (meth)acryloyl group.

Examples of the difunctional (meth)acrylate include ethylene glycol di(meth)acrylate, diethylene glycol di(meth)acrylate, triethylene glycol di(meth)acrylate, propylene glycol di(meth)acrylate, dipropylene glycol di(meth)acrylate, tripropylene glycol di(meth)acrylate, polyethylene glycol di(meth)acrylate, polypropylene glycol di(meth)acrylate, butylene glycol di(meth)acrylate, tetraethylene glycol di(meth)acrylate, neopentyl glycol di(meth)acrylate, 3-methyl-1,5-pentanediol di(meth)acrylate, hexanediol di(meth)acrylate, heptanediol di(meth)acrylate, EO-modified neopentyl glycol di(meth)acrylate, PO-modified neopentyl glycol di(meth)acrylate, EO-modified hexanediol di(meth)acrylate, PO-modified hexanediol di(meth)acrylate, octanediol di(meth)acrylate, nonanediol di(meth)acrylate, decanediol di(meth)acrylate, dodecanediol di(meth)acrylate, 1,6-hexanediol di(meth)acrylate, glycerin di(meth)acrylate, pentaerythritol di(meth)acrylate, ethylene glycol diglycidyl ether di(meth)acrylate, diethylene glycol diglycidyl ether di(meth)acrylate, and tricyclodecanedimethanol di(meth)acrylate.

Examples of the difunctional vinyl ether include 1,4-butanediol divinyl ether, ethylene glycol divinyl ether, diethylene glycol divinyl ether, triethylene glycol divinyl ether, polyethylene glycol divinyl ether, propylene glycol divinyl ether, butylene glycol divinyl ether, hexanediol divinyl ether, 1,4-cyclohexanedimethanol divinyl ether, bisphenol-A alkylene oxide divinyl ether, and bisphenol-F alkylene oxide divinyl ether.

Examples of the difunctional monomer that includes a vinyl ether group and a (meth)acryloyl group include 2-(2-vinyloxyethoxy)ethyl (meth)acrylate.

Trifunctional or Higher Functional Monomer

Examples of the trifunctional or higher functional monomer include a trifunctional or higher functional (meth)acrylate and a trifunctional or higher functional vinyl ether.

Examples of the trifunctional or higher functional (meth)acrylate include trimethylolethane tri(meth)acrylate, trimethylolpropane tri(meth)acrylate, EO-modified trimethylolpropane tri(meth)acrylate, PO-modified trimethylolpropane tri(meth)acrylate, pentaerythritol tri(meth)acrylate, pentaerythritol tetra(meth)acrylate, dipentaerythritol tetra(meth)acrylate, dipentaerythritol penta(meth)acrylate, dipentaerythritol hexa(meth)acrylate, tri(meth)acryloyloxyethoxytrimethylolpropane, glycerin polyglycidyl ether poly (meth)acrylate, and tris(2-acryloyloxyethyl)isocyanurate.

Examples of the trifunctional or higher functional vinyl ether include trimethylolethane trivinyl ether, trimethylolpropane trivinyl ether, ditrimethylolpropane tetravinyl ether, glycerin trivinyl ether, pentaerythritol tetravinyl ether, dipentaerythritol pentavinyl ether, dipentaerythritol hexavinyl ether, EO-modified trimethylolpropane trivinyl ether, PO-modified trimethylolpropane trivinyl ether, EO-modified ditrimethylolpropane tetravinyl ether, PO-modified ditrimethylolpropane tetravinyl ether, EO-modified pentaerythritol tetravinyl ether, PO-modified pentaerythritol tetravinyl ether, EO-modified dipentaerythritol hexavinyl ether, and PO-modified dipentaerythritol hexavinyl ether.

Urethane (Meth)acrylate

Examples of the above-described difunctional monomer and the above-described trifunctional or higher functional monomer also include a urethane (meth)acrylate.

Examples of the urethane (meth)acrylate include a urethane (meth)acrylate that is the product of reaction between a difunctional isocyanate compound and a hydroxyl group-containing (meth)acrylate.

Examples of the difunctional isocyanate compound include:

aliphatic diisocyanates, such as methylene diisocyanate, dimethylene diisocyanate, trimethylene diisocyanate, tetramethylene diisocyanate, pentamethylene diisocyanate, hexamethylene diisocyanate, dipropyl ether diisocyanate, 2,2-dimethylpentane diisocyanate, 3-methoxyhexane diisocyanate, octamethylene diisocyanate, 2,2,4-trimethylpentane diisocyanate, nonamethylene diisocyanate, decamethylene diisocyanate, 3-butoxyhexane diisocyanate, 1,4-butylene glycol dipropyl ether diisocyanate, and thiodihexyl diisocyanate;

aromatic diisocyanates, such as m-phenylene diisocyanate, p-phenylene diisocyanate, 2,4-tolylene diisocyanate, 2,6-tolylene diisocyanate, dimethylbenzene diisocyanate, ethylbenzene diisocyanate, isopropylbenzene diisocyanate, tolidine diisocyanate, 1,4-naphthalene diisocyanate, 1,5-naphthalene diisocyanate, 2,6-naphthalene diisocyanate, 2,7-naphthalene diisocyanate, meta-xylylene diisocyanate, para-xylylene diisocyanate, and tetramethylxylylene diisocyanate; and

alicyclic diisocyanates, such as hydrogenated xylylene diisocyanate, isophorone diisocyanate, and dicyclohexylmethane 4,4′-diisocyanate.

Examples of the hydroxyl group-containing (meth)acrylate include 2-hydroxyethyl (meth)acrylate, 3-hydroxypropyl (meth)acrylate, 2-hydroxypropyl (meth)acrylate, 2-hydroxybutyl (meth)acrylate, 3-hydroxybutyl (meth)acrylate, 4-hydroxybutyl (meth)acrylate, phenyl glycidyl ether (meth)acrylate, pentaerythritol (meth)triacrylate, and dipentaerythritol penta(meth)acrylate.

Epoxy (Meth)acrylate

Examples of the above-described difunctional monomer and the above-described trifunctional or higher functional monomer also include an epoxy (meth)acrylate.

Examples of the epoxy (meth)acrylate include the product of reaction between (meth)acrylic acid and an epoxy resin.

Examples of the epoxy resin include a bisphenol-A epoxy resin and a cresol novolac epoxy resin.

### Inorganic Oxide Particles

The ink according to the present disclosure includes at least one type of inorganic oxide particles.

Examples of the inorganic oxide particles include silica particles, alumina particles, and titania particles.

In order to further enhance the effect to reduce the gloss of the image, the inorganic oxide particles preferably include at least one of silica particles or alumina particles and more preferably include silica particles.

The silica particles may be silica particles having a degree of hydrophobicity of less than 50 (i.e., hydrophilic silica particles) and may be silica particles having a degree of hydrophobicity of 50 or more (i.e., hydrophobic silica particles). The silica particles are preferably silica particles having a degree of hydrophobicity of less than 50.

The degree of hydrophobicity of the silica particles can be measured by the following method.

First, the ink is centrifuged in order to extract silica particles. Then, 50 mL of ion-exchange water and 0.2 g of the extracted silica particles are charged into a beaker. While stirring is performed with a magnetic stirrer, methanol is added dropwise to the beaker with a burette. The silica particles gradually settle out with an increase in the methanol concentration in the beaker. The addition of methanol is terminated when the whole amount of silica particles have settled out. The mass fraction (% by mass) of methanol in the mixed solution of methanol and ion-exchange water which is measured at the timing when the addition of methanol is terminated is considered as a degree of hydrophobicity.

For example, in the case where the whole amount of silica particles have settled out at the timing when 75 g of methanol has been added dropwise, the mass fraction of methanol is:

(75/(50+75))×100=60% by mass, and

the degree of hydrophobicity of the silica particles is 60.

The average primary particle size of the inorganic oxide particles is preferably, but not limited to, 0.1 to 3.0 μm.

When the average primary particle size of the inorganic oxide particles is 0.1 μm or more, the effect to reduce the gloss of the image is produced in a further effective manner.

It is advantageous to set the average primary particle size of the inorganic oxide particles to 3.0 μm or less in tear's of the discharge performance of the ink.

In the case where the average primary particle size of the inorganic oxide particles is 3.0 μm or less, as described above, the inorganic oxide particles are unlikely to serve as a matting agent when the inorganic oxide particles are used alone. However, since the ink according to the present disclosure includes an acid generator, as described above, the inorganic oxide particles become aggregated to form aggregates on the surface side of the ink film, and these aggregates serve as a matting agent. As a result, the gloss of the image is reduced.

The average primary particle size of the inorganic oxide particles is more preferably 0.1 to 2.0 μm, is further preferably 0.1 to 1.0 μm, and is further preferably 0.1 to 0.7 μm.

In the present disclosure, the average primary particle size of the inorganic oxide particles is a value measured with a transmission electron microscope (TEM). In this measurement, a transmission electron microscope “1200EX” produced by JEOL Ltd. can be used.

Specifically, the ink diluted to 1,000 times is added dropwise to a Cu 200 mesh (produced by JEOL Ltd.) provided with a carbon film deposited thereon. After the deposited ink has been dried, an image is taken at a 100,000-fold magnification with a TEM. The equivalent circle diameters of 300 independent particles that do not overlap one another are measured on the basis of the image. The average of the measured values is considered as an average primary particle size.

The inorganic oxide particles may be a commercial product.

Examples of commercial inorganic oxide particles that are silica particles include

Seahostar KE-P30, Seahostar KE-P50, Seahostar KE-P100, Seahostar KE-P150, and Seahostar KE-P250 (the above are produced by Nippon Shokubai Co., Ltd.);

AEROSIL series (produced by Evonik); and

QSG-100 and QSG-170 (the above are produced by Shin-Etsu Chemical Co., Ltd.).

Examples of commercial inorganic oxide particles that are alumina particles include SMM-22 (produced by Nippon Light Metal Company, Ltd.).

The content of the inorganic oxide particles in the ink is preferably, but not limited to, 0.2% to 20.0% by mass, is more preferably 0.5% to 15.0% by mass, is further preferably 1.0% to 10.0% by mass, and is further preferably 1.5% to 8.0% by mass of the total amount of the ink.

When the content of the inorganic oxide particles is 0.2% by mass or more, the effect to reduce the gloss of the image and the abrasion resistance of the image are further enhanced.

When the content of the inorganic oxide particles is 20.0% by mass or less, the abrasion resistance of the image and the discharge performance of the ink are further enhanced.

### Amine Dispersing Agent

The ink according to the present disclosure preferably includes at least one amine dispersing agent.

In such a case, the discharge performance of the ink is further enhanced.

The reasons for which the above advantageous effect is produced is presumably that, when the ink includes an amine dispersing agent, the dispersibility of the inorganic oxide particles in the ink is further enhanced.

The amine dispersing agent is preferably an amine resin dispersing agent.

The amine dispersing agent may be a commercial product.

Examples of the commercial amine dispersing agent include SOLSPERSE series, such as SOLSPERSE 13940, 17000, 20000, 24000, 26000, 28000, 32000, 35000, 36000, and 39000 (produced by Noveon);

DISPERBYK series, such as DISPERBYK-108, 109, 161, 162, 163, 164, 167, 168, 180, 182, 184, 185, 2000, 2001, 2008, 2009, 2013, 2022, 2025, 2026, 2050, 2055, 2150, 2155, 2163, 2164, 9076, 9077, and DISPERBYK-9076 (produced by BYK Chemie);

BYKJET series, such as BYKJET-9150 and 9151 (produced by BYK Chemie);

Efka series, such as Efka PX4701, Efka PX4703, Efka PX4733, and Efka PU4063 (produced by BASF SE); and

Dispex Ultra PX 4575 (produced by BASF SE).

The content of the amine dispersing agent is preferably 20.0% to 80.0% by mass, is more preferably 30.0% to 70.0% by mass, and is further preferably 40.0% to 70.0% by mass of the total amount of the inorganic oxide particles.

### Photoacid Generator

The ink according to the present disclosure includes at least one photoacid generator.

The photoacid generator is not limited and may be any substance that generates an acid upon being irradiated with light.

In order to further enhance the effect to reduce the gloss of the image, the photoacid generator is

preferably a sulfonium salt or an iodonium salt,

more preferably a sulfonium salt, and

further preferably a sulfonium salt that includes at least one structure consisting of one S⁺ and three aromatic rings bonded thereto.

(Sulfonium Salt)

The sulfonium salt that serves as a photoacid generator is preferably the compound represented by any one of Formulae (1) to (4) below.

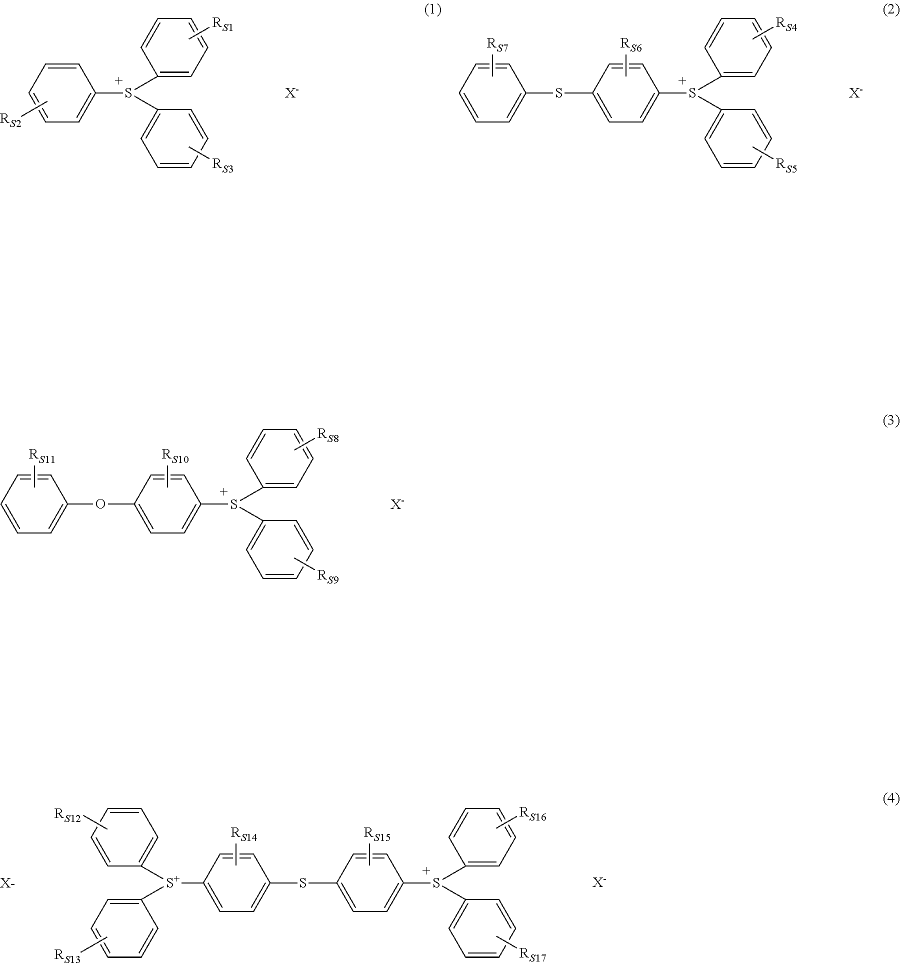

In Formulae (1) to (4), R_{S1} to R_{S17} each independently represent a hydrogen atom or a substituent; and

X⁻ represents an anion.

Examples of the anion represented by X⁻ include a halide ion (e.g., F⁻, Br⁻, or I⁻), B(C₆F₅)₄⁻, R₁₈COO⁻, R₁₉SO₃⁻, SbF₆⁻, AsF₆⁻, PF₆⁻, and BF₄⁻.

R₁₈ and R₁₉ each independently represent an alkyl group that may have a substituent, or a phenyl group that may have a substituent.

Examples of the substituents included in R₁₈ and R₁₉ include the substituents represented by R_{S1} to R_{S17}, which are described below.

The anion represented by X⁻ is preferably B(C₆F₅)₄⁻ or PF₆⁻.

Examples of the substituents represented by R_{S1} to R_{S17} include:

alkyl groups having 1 to 12 carbon atoms, such as a methyl group, an ethyl group, a propyl group, an isopropyl group, a butyl group, an isobutyl group, a t-butyl group, a pentyl group, a hexyl group, a decyl group, and a dodecyl group;

alkoxy groups having 1 to 12 carbon atoms, such as a methoxy group, an ethoxy group, a propyl group, a butoxy group, a hexyloxy group, a decyloxy group, and a dodecyloxy group;

acyl groups having 1 to 13 carbon atoms, such as a formyl group, an acetyl group, a propionyl group, a decylcarbonyl group, a dodecylcarbonyl group, and a benzoyl group;

acyloxy groups having 1 to 13 carbon atoms, such as a formyloxy group, an acetoxy group, a propionyloxy group, a decylcarbonyloxy group, a dodecylcarbonyloxy group, and a benzoyloxy group;

alkoxycarbonyl groups having 2 to 13 carbon atoms, such as a methoxycarbonyl group, an ethoxycarbonyl group, a butoxycarbonyl group, a hexyloxycarbonyl group, a decyloxycarbonyl group, and a dodecyloxycarbonyl group;

hydrocarbon thio groups having 1 to 12 carbon atoms, such as a methylthio group, an ethylthio group, a propylthio group, an isopropylthio group, a butylthio group, an isobutylthio group, a t-butylthio group, a pentylthio group, a hexylthio group, a decylthio group, a dodecylthio group, and a phenylthio group;

halogen atoms, such as a fluorine atom, a chlorine atom, a bromine atom, and an iodine atom;

a cyano group;

a nitro group; and

a hydroxyl group.

The above sulfonium salt can be readily synthesized by a method known in the related art, similarly to the photoacid generator described in THE CHEMICAL SOCIETY OF JAPAN Vol. 71 No. 11, 1998, Organic electronics material seminar, “Organic material for imaging”, Bun-shin publishing house (1993).

(Iodonium Salt)

The iodonium salt is preferably an iodonium salt that includes at least one structure consisting of one I⁺ and two aromatic rings bonded thereto.

The iodonium salt is more preferably the compound represented by Formula (I-1) below.

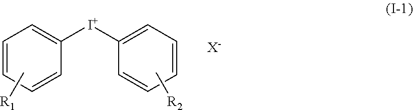

In Formula (I-1), R₁ and R₂ each independently represent a hydrogen atom or a substituent; and

X⁻ represents an anion.

Specific examples of the substituents represented by R₁ and R₂ in Formula (I-1) are the same as the specific examples of the substituents represented by R_{S1} to R_{S17} in Formulae (1) to (4).

Specific examples of the anion represented by X⁻ in Formula (I-1) are the same as the specific examples of the anion represented by X⁻ in Formulae (1) to (4).

The iodonium salt may be a commercial product.

Examples of commercial iodonium salts include:

Omnicat 440 (produced by IGM Resins B.V.); and

Irgacure 250 (produced by BASF SE).

The photoacid generator may be a commercial photoacid generator or a commercial composition that includes a photoacid generator.

Examples of the commercial photoacid generator and the commercial composition that includes a photoacid generator include:

CPI-100P, CPI-101A, CPI-110P, CPI-200K, CPI-210S, CPI-310B, CPI-4105, and IK-I (the above are produced by San-Apro Ltd.);

Omnicat 250 and Omnicat 270 (the above are produced by IGM Resins B.V.);

Irgacure 290 and Irgacure PAG103 (the above are produced by BASF SE); and

TS-91 and TS-01 (the above are produced by Nippon Carbide Industries Co., Inc.).

As a photoacid generator, for example, the compounds described in Paragraphs to [0017] and [0039] to [0048] of JP2006-152064A can be used.

The content of the photoacid generator in the ink is preferably, but not limited to, 0.1% to 15.0% by mass, is more preferably 0.2% to 15.0% by mass, is further preferably 0.5% to 10.0% by mass, is further preferably 1.0% to 9.0% by mass, and is further preferably 1.5% to 9.0% by mass of the total amount of the ink.

When the content of the photoacid generator is 0.1% by mass or more, the effect to reduce the gloss of the image is further enhanced.

When the content of the photoacid generator is 15.0% by mass or less, the content of the radical polymerizable monomer can be increased and, consequently, the abrasion resistance of the image is further enhanced.

The mass ratio of the content of the inorganic oxide particles to the content of the photoacid generator (hereinafter, this mass ratio is also referred to as “(b)/(c)”) is preferably, but not limited to, 0.1 to 80.0, is more preferably 0.2 to 15.0, is further preferably 0.5 to 10.0, and is further preferably 0.8 to 8.0 in order to further enhance the effect to reduce the gloss of the image and the abrasion resistance of the image.

In the calculation of “(b)/(c)”, the contents of the constituents (i.e., the photoacid generator and the inorganic oxide particles) are each the content of the constituent relative to the total amount of the ink, which is expressed in units of percent by mass, and are calculated to the first decimal place.

For example, in the case where the content of the photoacid generator relative to the total amount of the ink is 1.5% by mass and the content of the inorganic oxide particles relative to the total amount of the ink is 2.0% by mass, in the calculation of “(b)/(c)”, “1.5” is used as the content of the photoacid generator (corresponding to “(c)”) and “2.0” is used as the content of the inorganic oxide particles (corresponding to “(b)”).

The same applies to the handing of the contents of the constituents in the calculation of “(b)+(c)”, “(c)/(d)”, and “((a)+(b)+(c))/(d)” described below.

“(b)/(c)” is calculated to the first decimal place.

In the above example, “(b)/(c)” is calculated as “1.3”.

The total content of the inorganic oxide particles and the photoacid generator relative to the total amount of the ink (hereinafter, this content is also referred to as “(b)+(c)”) is preferably, but not limited to, 0.3% to 25.0% by mass, is more preferably 1.0% to 17.5% by mass, is further preferably 1.5% to 10.0% by mass, and is further preferably 2.0% to 8.0% by mass.

When “(b)+(c)” is 0.3% by mass or more, the effect to reduce the gloss of the image and the abrasion resistance of the image are further enhanced.

When “(b)+(c)” is 25.0% by mass or less, the effect to enhance the abrasion resistance of the image and the discharge performance of the ink are further enhanced.

### Cation Photosensitizer

The ink according to the present disclosure preferably includes at least one cation photosensitizer.

The cation photosensitizer may serve as a sensitizer for the photoacid generator.

Therefore, in the case where the ink according to the present disclosure includes the cation photosensitizer, the action of the photoacid generator can be further enhanced and, as a result, the effect to reduce the gloss of the image is further enhanced.

The cation photosensitizer is preferably a compound including an anthracene skeleton.

The compound including an anthracene skeleton is preferably a compound including an anthracene skeleton and alkoxy groups having 1 to 10 (preferably 1 to 6) carbon atoms which are bonded to the 9- and 10-positions of the anthracene skeleton or a compound including an anthracene skeleton and acyloxy groups having 1 to 20 (preferably 1 to 10) carbon atoms which are bonded to the 9- and 10-positions of the anthracene skeleton, and more preferably 9,10-diethoxyanthracene, 9,10-dibutoxyanthracene, or 9,10-di(capryloyloxy)anthracene.

The cation photosensitizer may be a commercial product.

Examples of the commercial product include:

ANTHRACURE UVS1331 (produced by Kawasaki Kasei Chemicals), which is a commercial product of 9,10-dibutoxyanthracene;

ANTHRACURE UVS1101, which is a commercial product of 9,10-diethoxyanthracene; and

ANTHRACURE UVS581, which is a commercial product of 9,10-di(capryloyloxy)anthracene.

The content of the cation photosensitizer relative to the total amount of the ink is preferably, but not limited to, 0.2% to 10.0% by mass, is more preferably 0.5% to 5.0% by mass, and is further preferably 0.5% to 4.0% by mass.

When the content of the cation photosensitizer is 0.2% by mass or more, the action of the photoacid generator can be further enhanced and, as a result, the effect to reduce the gloss of the image is further enhanced.

When the content of the cation photosensitizer is 10.0% by mass or less, the abrasion resistance of the image is further enhanced.

### Radical Photopolymerization Initiator

The ink according to the present disclosure includes at least one radical photopolymerization initiator.

Examples of the radical photopolymerization initiator include:

alkylphenone radical photopolymerization initiators, such as diethoxyacetophenone, 2-hydroxy-2-methyl-1-phenylpropan-1-one, benzyl dimethyl ketal, 1-(4-isopropylphenyl)-2-hydroxy-2-methylpropan-1-one, 4-(2-hydroxyethoxy)phenyl-(2-hydroxy-2-propyl)ketone, 1-hydroxycyclohexyl-phenyl ketone, 2-benzyl-2-(dimethylamino)-4′-morpholinobutyrophenone, and 2-methyl-1-[4-(methylthio)phenyl]-2-morpholinopropan-1-one;

benzoin radical photopolymerization initiators, such as benzoin, benzoin methyl ether, and benzoin isopropyl ether;

acylphosphine oxide radical photopolymerization initiators, such as bis(2,4,6-trimethylbenzoyl)phenylphosphine oxide and 2,4,6-trimethylbenzoindiphenylphosphine oxide;

benzyl glyoxy ester; and

methylphenyl glyoxy ester.

The above specific examples are useful as a low-molecular-weight radical photopolymerization initiator.

Note that the term “low-molecular-weight radical photopolymerization initiator” used herein refers to a photopolymerization initiator having a molecular weight of less than 500.

The radical photopolymerization initiator may include a high-molecular-weight radical photopolymerization initiator.

Note that the term “high-molecular-weight radical photopolymerization initiator” used herein refers to a photopolymerization initiator having a molecular weight of 500 or more.

The molecular weight of the high-molecular-weight radical photopolymerization initiator is preferably 500 to 3,000, is more preferably 700 to 2,500, and is further preferably 900 to 2,100.

The high-molecular-weight radical photopolymerization initiator is described in, for example, known documents, such as JP2017-105902A (Paragraphs [0038], etc.) and JP2017-522364A (Paragraphs [0017] to [0053]).

The radical photopolymerization initiator may be a commercial product.

Examples of the commercial product include:

“Omnirad TPO H” produced by IGM Resins B.V., which is a commercial product of 2,4,6-trimethylbenzoyldiphenylphosphine oxide;

“Omnirad 819” produced by IGM Resins B.V., which is a commercial product of bis(2,4,6-trimethylbenzoyl)phenylphosphine oxide;

“Omnirad 369” produced by IGM Resins B.V., which is a commercial product of 2-benzyl-2-(dimethylamino)-4′-morpholinobutyrophenone;

“Omnirad 907” produced by IGM Resins B.V., which is a commercial product of 2-methyl-1-[4-(methylthio)phenyl]-2-morpholinopropan-1-one; and

“Omnipol 910” produced by IGM Resins B.V., which is a commercial product of the high-molecular-weight radical photopolymerization initiator.

The content of the radical photopolymerization initiator is preferably 1.0% to 20.0% by mass, is more preferably 2.0% to 15.0% by mass, is further preferably 3.0% to 10.0% by mass, and is further preferably 3.0% to 8.0% by mass of the total amount of the ink.

When the content of the radical photopolymerization initiator is 1.0% to 20.0% by mass, the abrasion resistance of the image is further enhanced.

The mass ratio of the content of the photoacid generator to the content of the radical photopolymerization initiator (hereinafter, this mass ratio is also referred to as “(c)/(d)”) is preferably 0.01 to 2.50, is preferably 0.02 to 2.50, is more preferably 0.03 to 2.00, and is further preferably 0.04 to 1.50 in order to further enhance the effect to reduce the gloss of the image and the abrasion resistance of the image.

The mass ratio “(c)/(d)” is calculated to the second decimal place.

The mass ratio of the total content of the radical polymerizable monomer, the inorganic oxide particles, and the photoacid generator to the content of the radical photopolymerization initiator (hereinafter, this mass ratio is also referred to as “((a)+(b)+(c))/(d)”) is preferably 5.0 to 90.0, is more preferably 6.0 to 45.0, is further preferably 8.0 to 30.0, is further preferably 8.0 to 20.0, and is further preferably 8.0 to 15.0 in order to further enhance the effect to reduce the gloss of the image and the abrasion resistance of the image.

The mass ratio “((a)+(b)+(c))/(d)” is calculated to the first decimal place.

### Radical Photosensitizer

The ink according to the present disclosure preferably includes at least one radical photosensitizer in order to further enhance the abrasion resistance of the image.

Examples of the radical photosensitizer include:

benzophenone radical photosensitizers, such as benzophenone, methyl o-benzoylbenzoate-4-phenylbenzophenone, 4,4′-dichlorobenzophenone, hydroxybenzophenone, 4-benzoyl-4′-methyl-diphenyl sulfide, acrylated benzophenone, 3,3′,4,4′-tetra(t-butylperoxycarbonyl) benzophenone, and 3,3′-dimethyl-4-methoxybenzophenone; and

thioxanthone radical photosensitizers, such as thioxanthone, 2-isopropylthioxanthone, 2-chlorothioxanthone, 2,4-dichlorothioxanthone, 2-dodecylthioxanthone, 2,4-diethylthioxanthone, 2,4-dimethylthioxanthone, 1-methoxycarbonylthioxanthone, 2-ethoxycarbonylthioxanthone, 3-(methoxyethoxycarbonyl)thioxanthone, 4-butoxycarbonylthioxanthone, 3-butoxycarbonyl-7-methylthioxanthone, 1-cyclo-3-chloroxanthone, 1-ethoxycarbonyl-3-chlorothioxanthone, 1-ethoxycarbonyl-3-ethoxythioxanthone, 1-ethoxycarbonyl-3-aminothioxanthone, 1-ethoxycarbonyl-3-phenylsulfurylthioxanthone, 3,4-di[2-(methoxyethoxy)ethoxycarbonyl)]thioxanthone], 1-ethoxycarbonyl-3-(1-methyl-1-morpholinoethyl)thioxanthone], 2-methyl-6-dimethoxymethylthioxanthone, 2-methyl-6-(1,1-dimethoxybenzyl)thioxanthone, 2-morpholinomethylthioxanthone, 2-methyl-6-morpholinomethylthioxanthone, N-allylthioxanthone-3,4-dicarboxyimide, N-octylthioxanthone-3,4-dicarboxyimide, N-(1,1,3,3-tetramethylbutyl)-thioxanthone-3,4-dicarboxyimide, 1-phenoxythioxanthone, 6-ethoxycarbonyl-1-2-methoxythioxanthone, 6-ethoxycarbonyl-2-methylthioxanthone, thioxanthone-2-polyethylene glycol ester, 2-hydroxy-3-(3,4-dimethyl-9-oxo-9H-thioxanthon-2-yloxy)-N,N,N-trimethyl-1-propanaminium chloride, n-dodecyl-7-methyl-thioxanthone-3-carboxylate, and N,N-diisobutyl-7-methyl-thioxanthone-3-carbamide.

The above specific examples are useful as a low-molecular-weight radical photosensitizer.

The term “low-molecular-weight radical photosensitizer” used herein refers to a sensitizer having a molecular weight of less than 500.

The radical photosensitizer may include a high-molecular-weight radical photosensitizer.

The term “high-molecular-weight radical photosensitizer” used herein refers to a sensitizer having a molecular weight of 500 to 5,000.

The molecular weight of the high-molecular-weight radical photosensitizer is preferably 500 to 3,000, is more preferably 800 to 2,500, and is further preferably 900 to 2,100.

The high-molecular-weight radical photosensitizer is described in, for example, Paragraphs [0035] to [0053] of JP2014-162828A.

Examples of commercial high-molecular-weight radical photosensitizers include:

“Speedcure (registered trademark) 7010” produced by Lambson (1,3-di({α-[1-chloro-9-oxo-9H-thioxanthen-4-yl]oxy}acetylpoly[oxy(1-methylethylene)]oxy)-2,2-bis({α-[1-chloro-9-oxo-9H-thioxanthen-4-yl]oxy}acetylpoly[oxy(1-methylethylene)]oxymethyl)propane, CAS No. 1003567-83-6);

“OMNIPOL (registered trademark) TX” produced by IGM Resins B.V. (polybutyleneglycol bis(9-oxo-9H-thioxanthenyloxy)acetate, CAS No. 813452-37-8);

“OMNIPOL BP” produced by IGM Resins B.V. (polybutyleneglycol bis(4-benzoylphenoxy)acetate, CAS No. 515136-48-8); and

“Genopo TX-T” produced by Ran A.G.

In the case where the ink according to the present disclosure includes the radical photosensitizer, the content of the radical photosensitizer is preferably 0.1% to 15% by mass, is more preferably 0.5% to 10% by mass, and is further preferably 1% to 5% by mass of the total amount of the ink.

### Gelling Agent

The ink according to the present disclosure may include a gelling agent.

Examples of the gelling agent that can be included in the ink according to the present disclosure include gelling agents known in the related art, which are described in, for example, Paragraphs [0018] to [0032] of WO2015/133605.

The gelling agent that can be included in the ink according to the present disclosure is preferably at least one selected from the group consisting of an ester compound including a chain alkyl group having 12 or more carbon atoms and a ketone compound including a chain alkyl group having 12 or more carbon atoms.

The ester compound including a chain alkyl group having 12 or more carbon atoms is preferably the ester compound represented by Formula (G1) below.

The ketone compound including a chain alkyl group having 12 or more carbon atoms is preferably the ketone compound represented by Formula (G2) below.

R¹—COO—R² (G1)

R³—CO—R⁴ (G2)

In Formulae (G1) and (G2), R¹ to R⁴ each independently represent a chain alkyl group having 12 or more carbon atoms.

The alkyl groups represented by R¹ to R⁴ may include a branched portion.

The number of the carbon atoms included in each of the alkyl groups represented by R¹ to R⁴ is preferably 12 to 26.

The melting point of the gelling agent is preferably 40° C. to 90° C., is more preferably 50° C. to 80° C., and is further preferably 60° C. to 80° C.

In the case where the ink according to the present disclosure includes the gelling agent, the content of the gelling agent is preferably 0.1% to 5.0% by mass, is more preferably 0.1% to 4.0% by mass, and is further preferably 0.5% to 2.5% by mass of the total amount of the ink.

### Coloring Material

The ink according to the present disclosure may include, but does not necessarily include, at least one coloring material.

The coloring material may be either a visible coloring material or an invisible coloring material.

The visible coloring material is preferably a coloring material such that, when a solution including the coloring material at a concentration of 0.01% by mass is prepared, the absorbance of the solution at wavelengths of 400 to 650 nm is more than 0.3.

The invisible coloring material is preferably a coloring material such that, when a solution including the coloring material at a concentration of 0.01% by mass is prepared, the absorbance of the solution at wavelengths of 400 to 650 nm is 0.3 or less.

The invisible coloring material is preferably capable of absorbing infrared radiation.

The expression “capable of absorbing infrared radiation” used herein means that, when a solution including the substance at a concentration of 0.01% by mass is prepared, the highest absorbance of the solution at wavelengths of 650 to 1,100 nm is 0.3 or more.

In the case where the ink according to the present disclosure includes the coloring material, the content of the coloring material is preferably 1% to 20% by mass and is more preferably 2% to 10% by mass of the total amount of the ink.

In the case where the ink according to the present disclosure is a clear ink used for recording a clear image, the ink according to the present disclosure does not necessarily include the coloring material substantially. In this case, the content of the coloring material may be less than 1% by mass, may be less than 0.1% by mass, and may be 0% by mass of the total amount of the ink.

The term “clear image” used herein refers to an image the transmittance of which at wavelengths of 400 to 700 nm is 80% or more.

The coloring material is not limited and can be selected from coloring materials known in the related art, such as a pigment and a dye.

Among these, a pigment is more preferable in consideration of weather resistance.

Examples of the pigment also include resin particles colored with a dye, a commercial pigment dispersion, and a surface-treated pigment (e.g., a pigment dispersion prepared by dispersing a pigment in a dispersion medium, such as a radical photopolymerizable monomer or an organic solvent, and a surface-treated pigment prepared by treating the surfaces of pigment particles with a resin, a pigment derivative, or the like).

Examples of the pigment include a visible pigment, such as a yellow pigment, a red pigment, a magenta pigment, a blue pigment, a cyan pigment, a green pigment, an orange pigment, a purple pigment, a brown pigment, a black pigment, or a white pigment.

Examples of the pigment also include an invisible pigment capable of absorbing infrared radiation.

In the case where the ink according to the present disclosure includes a pigment as a coloring material, the ink according to the present disclosure may further include a pigment dispersing agent.

For details of the pigment and the pigment dispersing agent, the documents known in the related art, such as Paragraphs [0060] to [0074] of WO2015/133605A, Paragraphs [0152] to [0158] of JP2011-225848A, and Paragraphs [0132] to [0149] of JP2009-209352A, may be referred as needed.

Examples of the invisible pigment capable of absorbing infrared radiation include an infrared absorbing pigment having a cyanine skeleton, a squarylium pigment, and an infrared absorbing pigment having a phthalocyanine skeleton.

The term “cyanine skeleton” used herein refers to a skeleton including two nitrogen-containing hetero rings and a plurality of methine groups interposed between the two nitrogen-containing hetero rings.

The invisible pigment capable of absorbing infrared radiation is particularly preferably a squarylium pigment.

Squarylium Pigment

The squarylium pigment is preferably a squarylium pigment having a volume average particle size of 10 to 400 nm.

When the volume average particle size of the squarylium pigment is 10 nm or more, the weather resistance (in particular, light fastness) of the ink and/or image can be enhanced. The volume average particle size of the squarylium pigment is preferably 15 nm or more, is more preferably 20 nm or more, and is further preferably 50 nm or more.

When the average particle size of the squarylium pigment is 400 nm or less, the discharge performance of the ink can be maintained. The volume average particle size of the squarylium pigment is preferably 300 nm or less and is more preferably 200 nm or less.

The volume average particle size of the squarylium pigment can be measured by dynamic light scattering using a Nanotrac UPA grain size analyzer (product name “UPA-EX150”, produced by Nikkiso Co., Ltd.) as a measuring equipment. After a 3 mL of a squarylium pigment dispersion has been charged into a measurement cell, the measurement can be conducted in accordance with a predetermined measuring method. As for the parameters inputted for the measurement, the viscosity of the ink is used as viscosity, and the density of the squarylium pigment is used as particle density.

The volume average particle size of the squarylium pigment can be adjusted by changing the conditions under which the squarylium pigment is dispersed, that is, specifically, the type of the dispersing agent used, the concentration of the squarylium pigment, the combination of the radical polymerizable monomer and the dispersing agent, and the like.

The squarylium pigment is preferably a pigment that is the squarylium colorant represented by Formula (SQ1).

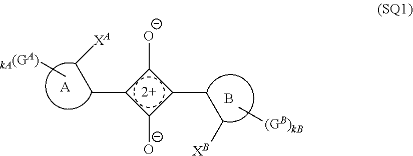

In Formula (SQ1), the rings A and B each independently represent an aromatic or heteroaromatic ring; X^{A} and X^{B} each independently represent a monovalent substituent; G^{A} and G^{B} each independently represent a monovalent substituent; kA represents an integer of 0 to nA; and kB represents an integer of 0 to nB, where nA represents an integer that is the maximum number of G^{A} substituents the ring A can have and nB represents an integer that is the maximum number of G^{B} substituents the ring B can have. X^{A} and G^{A} or X^{B} and G^{B} may be bonded to each other to form a ring. In the case where a plurality of G^{A}'s and a plurality of G^{B}'s are present, the G^{A}'s bonded to the ring A may be bonded to one another to form a ring structure, and the G^{B}'s bonded to the ring B may be bonded to one another to form a ring structure.

G^{A} and G^{B} each independently represent a monovalent substituent.

Examples of the monovalent substituent include a halogen atom, a cyano group, a nitro group, an alkyl group, an alkenyl group, an alkynyl group, an aryl group, a heteroaryl group, an aralkyl group, —OR¹⁰, —COR¹¹, —COOR¹², —OCOR¹³, —NR¹⁴R¹⁵, —NHCOR¹⁶, —CONR¹⁷R¹⁸, —NHCONR¹⁹R²⁰, —NHCOOR²¹, —SR²², —SO₂R²³, —SO₂OR²⁴, —NHSO₂R²⁵, and SO₂NR²⁶R²⁷.

R¹⁰ to R²⁷ each independently represent a hydrogen atom, an aliphatic group, an aromatic group, or a heterocyclic group.

In the case where R¹² of —COOR¹² is a hydrogen atom (i.e., a carboxyl group), the hydrogen atom may be dissociated (i.e., a carbonate group) or a salt may be formed. In the case where R²⁴ of —SO₂OR²⁴ is a hydrogen atom (i.e., a sulfo group), the hydrogen atom may be dissociated (i.e., a sulfonate group) or a salt may be formed.

Examples of the halogen atom include a fluorine atom, a chlorine atom, a bromine atom, and an iodine atom.

The number of carbon atoms included in the alkyl group is preferably 1 to 20, is more preferably 1 to 15, and is further preferably 1 to 8. The alkyl group may be any of linear, branched, or cyclic and is preferably linear or branched.

The number of carbon atoms included in the alkenyl group is preferably 2 to 20, is more preferably 2 to 12, and is particularly preferably 2 to 8. The alkenyl group may be any of linear, branched, or cyclic and is preferably linear or branched.

The number of carbon atoms included in the alkynyl group is preferably 2 to 40, is more preferably 2 to 30, and is particularly preferably 2 to 25. The alkynyl group may be any of linear, branched, or cyclic and is preferably linear or branched.

The number of carbon atoms included in the aryl group is preferably 6 to 30, is more preferably 6 to 20, and is further preferably 6 to 12.

The alkyl portion of the aralkyl group is the same as the alkyl group described above. The aryl portion of the aralkyl group is the same as the aryl group described above. The number of carbon atoms included in the aralkyl group is preferably 7 to 40, is more preferably 7 to 30, and is further preferably 7 to 25.

The heteroaryl group is preferably a monocyclic or fused-ring heteroaryl group, is preferably a monocyclic heteroaryl group or a fused-ring heteroaryl group formed by condensation of 2 to 8 rings, and is more preferably a monocyclic heteroaryl group or a fused-ring heteroaryl group formed by condensation of 2 to 4 rings. The number of hetero atoms constituting the ring of the heteroaryl group is preferably 1 to 3. The hetero atom constituting the ring of the heteroaryl group is preferably a nitrogen atom, an oxygen atom, or a sulfur atom. The heteroaryl group is preferably a five- or six-membered ring. The number of carbon atoms constituting the ring of the heteroaryl group is preferably 3 to 30, is more preferably 3 to 18, and is more preferably 3 to 12. Examples of the heteroaryl group include a pyridine ring, a piperidine ring, a furan ring group, a furfuran ring, a thiophene ring, a pyrrole ring, a quinoline ring, a morpholine ring, an indole ring, an imidazole ring, a pyrazole ring, a carbazole ring, a phenothiazine ring, a phenoxazine ring, an indoline ring, a thiazole ring, a pyrazine ring, a thiadiazin ring, a benzoquinoline ring, and a thiadiazole ring.

The alkyl group, the alkenyl group, the alkynyl group, the aralkyl group, the aryl group, and the heteroaryl group may have a substituent and may be unsubstituted.

Examples of the substituent include the substituents described in Paragraph [0030] of JP2018-154672A. The substituent is preferably a substituent selected from the group consisting of an alkyl group, an aryl group, an amino group, an alkoxy group, an aryloxy group, an aromatic heterocyclic oxy group, an acyl group, an alkoxycarbonyl group, an aryloxycarbonyl group, an acyloxy group, an acylamino group, an alkoxycarbonylamino group, an aryloxycarbonylamino group, a sulfonylamino group, an alkylthio group, an arylthio group, an aromatic heterocyclic thio group, a sulfonyl group, a hydroxyl group, a mercapto group, a halogen atom, a cyano group, a sulfo group, and a carboxyl group. Among these, a substituent selected from the group consisting of an alkyl group, an aryl group, an alkoxy group, an aryloxy group, an aromatic heterocyclic oxy group, an acyl group, an alkoxycarbonyl group, an aryloxycarbonyl group, an acyloxy group, an alkylthio group, an arylthio group, an aromatic heterocyclic thio group, a sulfonyl group, a hydroxyl group, a mercapto group, a halogen atom, a cyano group, a sulfo group, and a carboxyl group is more preferable.

Note that the expression “number of carbon atoms” of a substituent means the total number of carbon atoms included in the substituent.

For details of the above substituents, the substituents described in Paragraphs [0031] to of JP2018-154672A may be referred.

X^{A} and X^{B} each independently represent a monovalent substituent.

The substituents represented by X^{A} and X^{B} are preferably groups having active hydrogen, are more preferably —OH, —SH, —COOH, —SO₃H, —NR^{X1}R^{X2}, —NHCOR^{X1}, —CONR^{X1}R^{X2}, —NHCONR^{X1}R^{X2}, —NHCOOR^{X1}, —NHSO₂R^{X1}, —B(OH)₂, or PO(OH)₂, and are further preferably —OH, —SH, or NR^{X1}R^{X2}.

R^{X1} and R^{X2} each independently represent a hydrogen atom or a monovalent substituent. Examples of the substituent include an alkyl group, an alkenyl group, an alkynyl group, an aryl group, and a heteroaryl group. An alkyl group is preferable. The alkyl group is preferably linear or branched. Details of the alkyl group, the alkenyl group, the alkynyl group, the aryl group, and the heteroaryl group are the same as those described in the description of G^{A} and G^{B}.

The rings A and B each independently represent an aromatic ring or a heteroaromatic ring.

The aromatic ring and the heteroaromatic ring may be single rings or fused rings.

Specific examples of the aromatic ring and the heteroaromatic ring include a benzene ring, a naphthalene ring, a pentalene ring, an indene ring, an azulene ring, a heptalene ring, an indecene ring, a perylene ring, a pentacene ring, an acetaphthalene ring, a phenanthrene ring, an anthracene ring, a naphtacene ring, a chrysene ring, a triphenylene ring, a fluorene ring, a biphenyl ring, a pyrrole ring, a furan ring, a thiophene ring, an imidazole ring, an oxazole ring, a thiazole ring, a pyridine ring, a pyrazine ring, a pyrimidine ring, a pyridadine ring, an indolidine ring, an indole ring, a benzofuran ring, a benzothiophene ring, an isobenzofuran ring, a quinolizine ring, a quinoline ring, a phthalazine ring, a naphthyridine ring, a quinoxaline ring, a quinoxazoline ring, an isoquinoline ring, a carbazole ring, a phenanthridine ring, an acridine ring, a phenanthroline ring, a thianthrene ring, a chromene ring, a xanthene ring, a phenoxathiin ring, a phenothiazine ring, and a phenazine ring. A benzene ring and a naphthalene ring are preferable.

The aromatic ring may be unsubstituted and may have a substituent. Examples of the substituent include the substituents described in the description of G^{A} and G^{B}.

X^{A} and G^{A} may be bonded to each other to form a ring. X^{B} and G^{B} may be bonded to each other to form a ring. In the case where a plurality of G^{A}'s and a plurality of G^{B}'s are present, the G^{A}'s may be bonded to one another to form a ring structure, and the G^{B}'s may be bonded to one another to form a ring structure.

The ring is preferably a five- or six-membered ring. The ring may be either a single ring or a multi-ring.

In the case where X^{A} and G^{A} or X^{B} and G^{B} are bonded to each other or a plurality of G^{A}'s or G^{B}'s are bonded to one another to form a ring, they may be directly bonded to form a ring or may be bonded with a divalent linking group selected from the group consisting of an alkylene group, —CO—, —O—, —NH—, —BR—, and a combination thereof being interposed therebetween to form a ring. It is preferable that X^{A} and G^{A}, X^{B} and G^{B}, or a plurality of G^{A}'s or G^{B}'s be bonded to one another with —BR— being interposed therebetween to form a ring.

R represents a hydrogen atom or a monovalent substituent. Examples of the substituent include the substituents described in the description of G^{A} and G^{B}. An alkyl group and an aryl group are preferable.

kA represents an integer of 0 to nA, and kB represents an integer of 0 to nB, where nA represents an integer that is the maximum number of G^{A} substituents the ring A can have and nB represents an integer that is the maximum number of G^{B} substituents the ring B can have.

kA and kB are preferably each independently 0 to 4, are more preferably each independently 0 to 2, and are particularly preferably each independently 0 or 1. It is preferable that kA and kB do not represent 0 (zero) at the same time.

Among the squarylium colorants represented by Formula (SQ1), the squarylium colorant represented by Formula (SQ2) below is preferable in consideration of resistance to light.

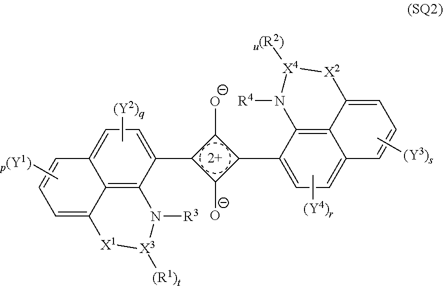

In Formula (SQ2), R¹ and R² each independently represent a monovalent substituent; R³ and R⁴ each independently represent a hydrogen atom or an alkyl group;

X¹ and X² each independently represent an oxygen atom or —N(R⁵)—; X³ and X⁴ each independently represent a carbon atom or a boron atom;

t represents 1 when X³ is a boron atom and represents 2 when X³ is a carbon atom; in the case where X³ is a carbon atom and t is 2, two R¹'s may be bonded to each other to form a ring;

u represents 1 when X⁴ is a boron atom and represents 2 when X⁴ is a carbon atom; in the case where X⁴ is a carbon atom and u is 2, two R²'s may be bonded to each other to form a ring;
R⁵ represents a hydrogen atom, an alkyl group, an aryl group, or a heteroaryl group; Y¹, Y², Y³, and Y⁴ each independently represent a monovalent substituent; Y¹ and Y² may be bonded to each other to form a ring; Y³ and Y⁴ may be bonded to each other to form a ring;

in the case where a plurality of Y¹'s, Y²'s, Y³'s, or Y⁴'s are present, they may be bonded to one another to form a ring; and

p and s each independently represent an integer of 0 to 3; q and r each independently represents an integer of 0 to 2.

Examples of the substituents represented by R¹, R², Y¹, Y², Y³ and Y⁴ are also the same as the substituents described in the description of G^{A} and G^{B}.

R³ and R⁴ each independently represent a hydrogen atom or an alkyl group. The number of carbon atoms included in the alkyl group represented by R³ is, for example, 1 to 4 and is preferably 1 or 2. The alkyl group may be linear or branched. Specific examples thereof include a methyl group, an ethyl group, a propyl group, an isopropyl group, a butyl group, and an isobutyl group. R³ is preferably a hydrogen atom, a methyl group, or an ethyl group, is more preferably a hydrogen atom or a methyl group, and is particularly preferably a hydrogen atom.

X¹ and X² each independently represent an oxygen atom (—O—) or —N(R⁵)—. X¹ and X² may be the same as or different from each other and are preferably the same as each other.

R⁵ represents a hydrogen atom, an alkyl group, an aryl group, or a heteroaryl group.

R⁵ is preferably a hydrogen atom, an alkyl group, or an aryl group and is more preferably a hydrogen atom or an alkyl group. The alkyl group, aryl group, or heteroaryl group represented by R⁵ may be unsubstituted and may have a monovalent substituent. Examples of the monovalent substituent include the monovalent substituents described in the description of G^{A} and G^{B}.

The number of carbon atoms included in the alkyl group is preferably 1 to 20, is more preferably 1 to 10, is further preferably 1 to 4, and is particularly preferably 1 or 2. The alkyl group may be either linear or branched.

The number of carbon atoms included in the aryl group is preferably 6 to 20 and is more preferably 6 to 12.

The heteroaryl group may be either a single ring or a multi-ring. The number of hetero atoms constituting the ring of the heteroaryl group is preferably 1 to 3. The hetero atom constituting the ring of the heteroaryl group is preferably a nitrogen atom, an oxygen atom, or a sulfur atom. The number of carbon atoms constituting the ring of the heteroaryl group is preferably 3 to 30, is more preferably 3 to 18, and is more preferably 3 to 12.

The molecular weight of the squarylium colorant represented by Formula (SQ1) or (SQ2) above is preferably 100 to 2,000 and is more preferably 150 to 1,000.

The squarylium colorant represented by Formula (SQ2) is described in detail in JP2011-208101A. The compounds described in this document can be suitably used as a squarylium colorant in the present disclosure.

Specific examples (Specific Examples B-1 to B-41) of the squarylium colorant represented by Formula (SQ1) or (SQ2) above are described below. Note that, in the present disclosure, the squarylium colorant is not limited to the following compounds. In the following formulae, “Me” represents a methyl group, and “Ph” represents a phenyl group.

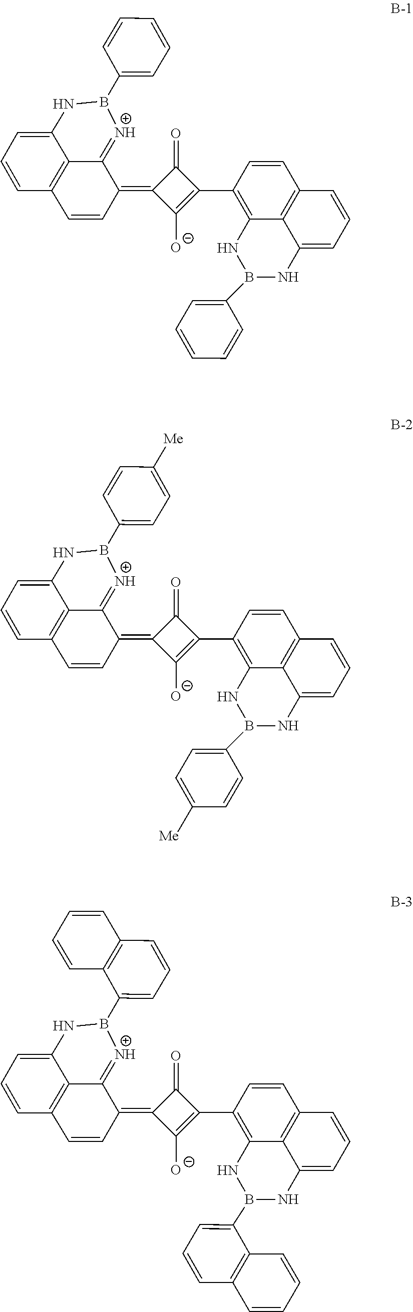 [SMILES: O=C1C(c2ccc3cccc4c3c2NB(c2ccccc2)N4)=C([O-])/C1=c1\ccc2cccc3c2c1=[NH+]B(c1ccccc1)N3 ; Cc1ccc(B2Nc3cccc4ccc(C5=C([O-])/C(=c6\ccc7cccc8c7c6=[NH+]B(c6ccc(C)cc6)N8)C5=O)c(c34)N2)cc1 ; O=C1C(c2ccc3cccc4c3c2NB(c2cccc3ccccc23)N4)=C([O-])/C1=c1\ccc2cccc3c2c1=[NH+]B(c1cccc2ccccc12)N3]

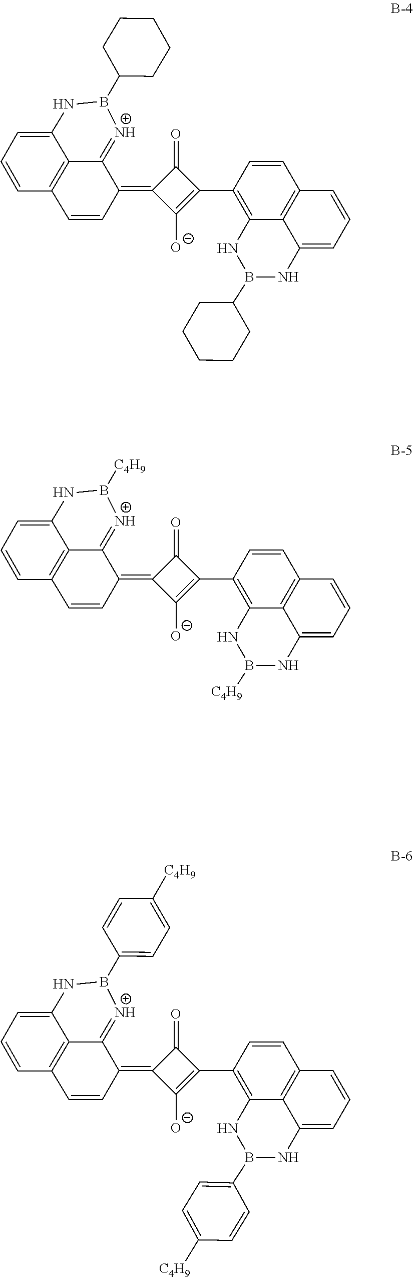

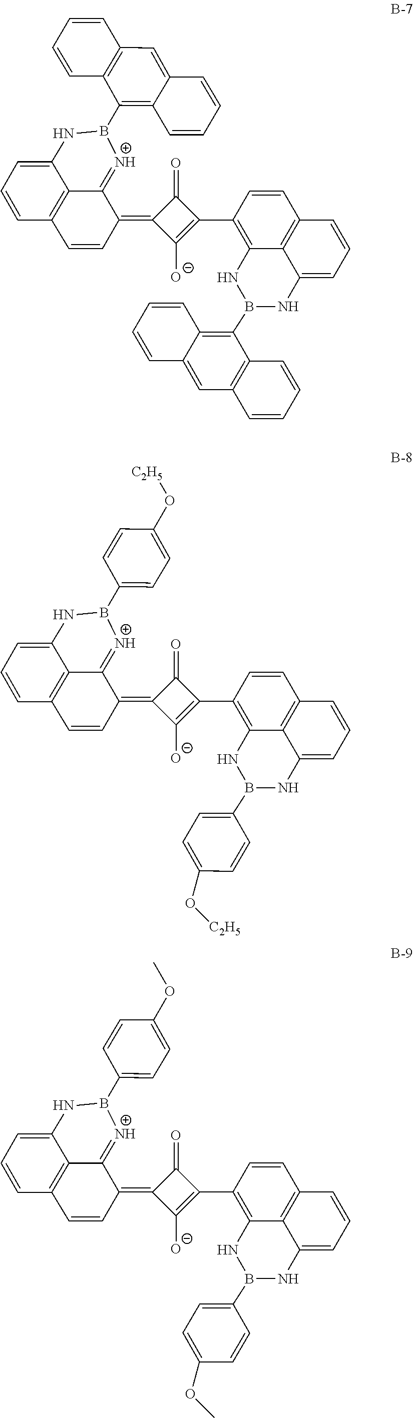 [SMILES: O=C1C(c2ccc3cccc4c3c2NB(c2c3ccccc3cc3ccccc23)N4)=C([O-])/C1=c1\ccc2cccc3c2c1=[NH+]B(c1c2ccccc2cc2ccccc12)N3 ; CCOc1ccc(B2Nc3cccc4ccc(C5=C([O-])/C(=c6\ccc7cccc8c7c6=[NH+]B(c6ccc(OCC)cc6)N8)C5=O)c(c34)N2)cc1 ; COc1ccc(B2Nc3cccc4ccc(C5=C([O-])/C(=c6\ccc7cccc8c7c6=[NH+]B(c6ccc(OC)cc6)N8)C5=O)c(c34)N2)cc1]

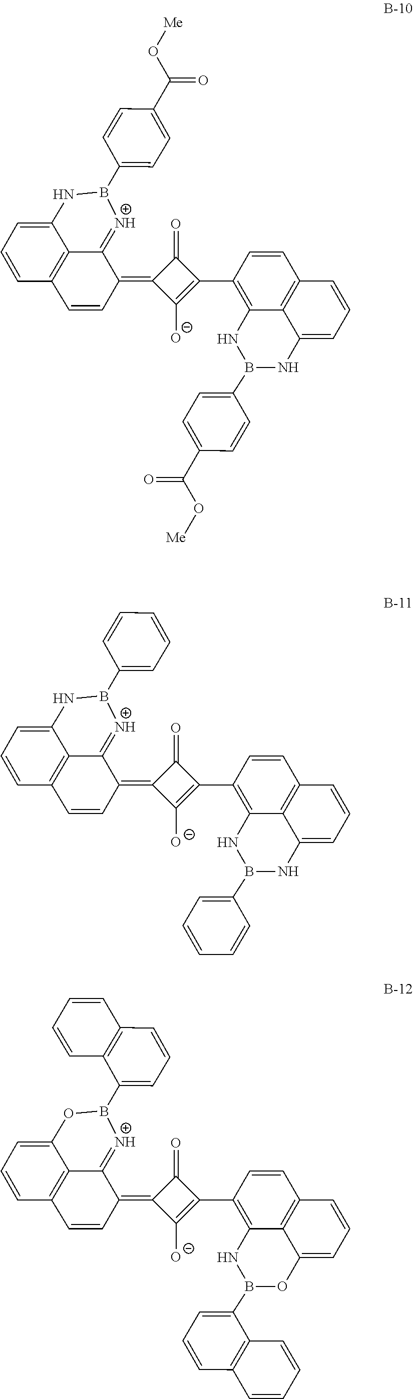 [SMILES: COC(=O)c1ccc(B2Nc3cccc4ccc(C5=C([O-])/C(=c6\ccc7cccc8c7c6=[NH+]B(c6ccc(C(=O)OC)cc6)N8)C5=O)c(c34)N2)cc1 ; O=C1C(c2ccc3cccc4c3c2NB(c2ccccc2)N4)=C([O-])/C1=c1\ccc2cccc3c2c1=[NH+]B(c1ccccc1)N3 ; O=C1C(c2ccc3cccc4c3c2NB(c2cccc3ccccc23)O4)=C([O-])/C1=c1\ccc2cccc3c2c1=[NH+]B(c1cccc2ccccc12)O3]

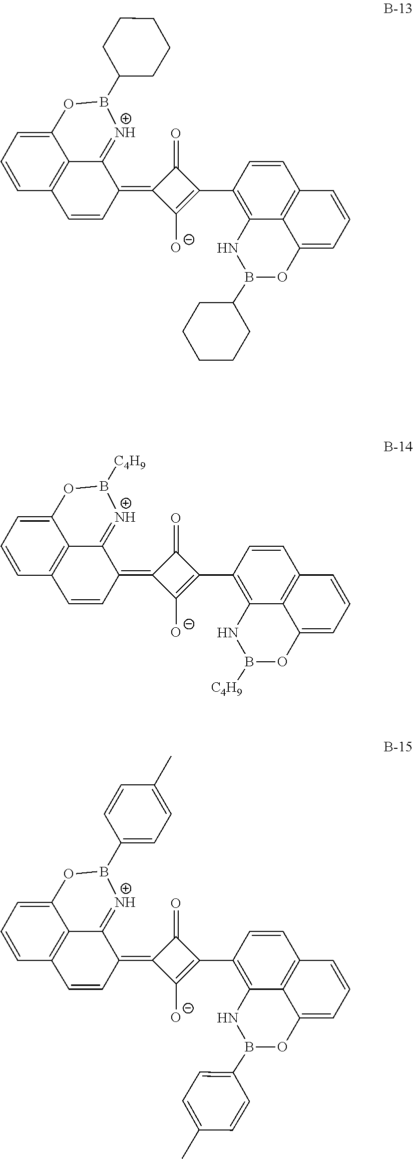

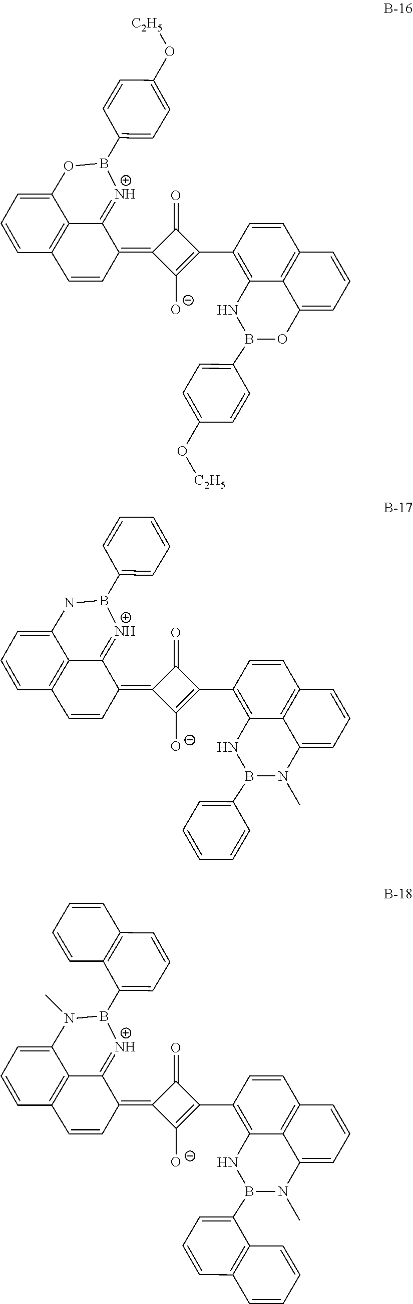 [SMILES: CCOc1ccc(B2Nc3c(C4=C([O-])/C(=c5\ccc6cccc7c6c5=[NH+]B(c5ccc(OCC)cc5)O7)C4=O)ccc4cccc(c34)O2)cc1 ; CN1B(c2ccccc2)Nc2c(C3=C([O-])/C(=c4\ccc5cccc6c5c4=[NH+]B(c4ccccc4)N6)C3=O)ccc3cccc1c23 ; CN1B(c2cccc3ccccc23)Nc2c(C3=C([O-])/C(=c4\ccc5cccc6c5c4=[NH+]B(c4cccc5ccccc45)N6C)C3=O)ccc3cccc1c23]

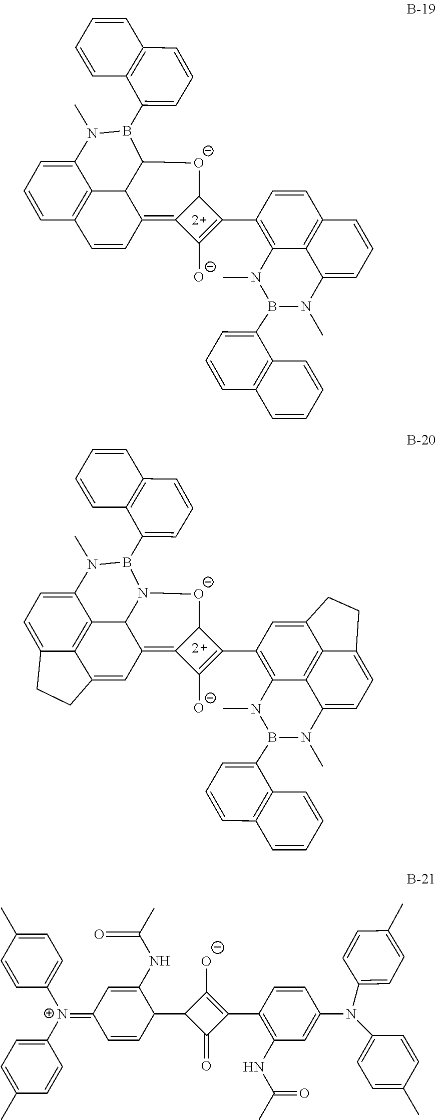

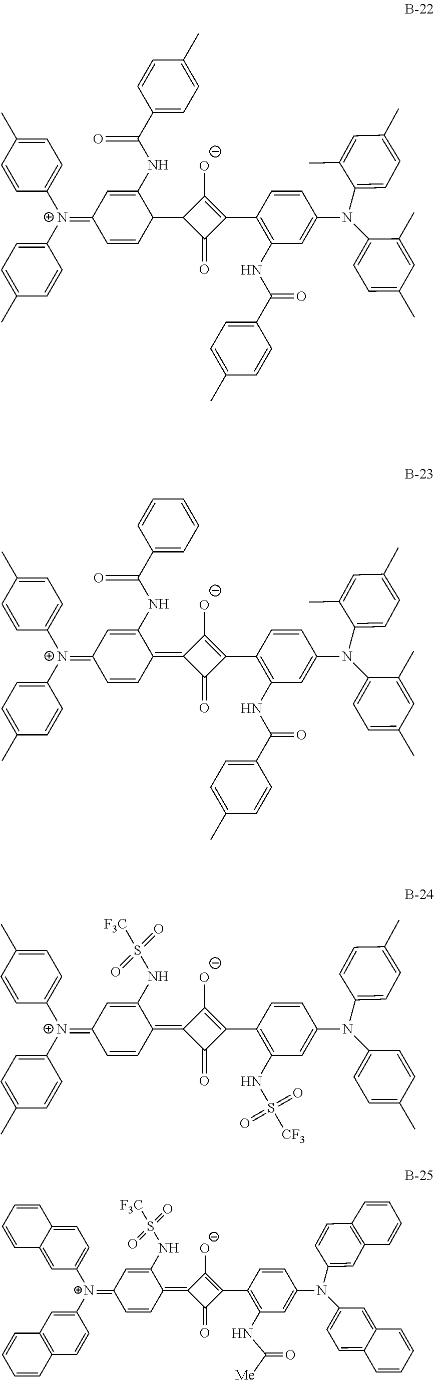

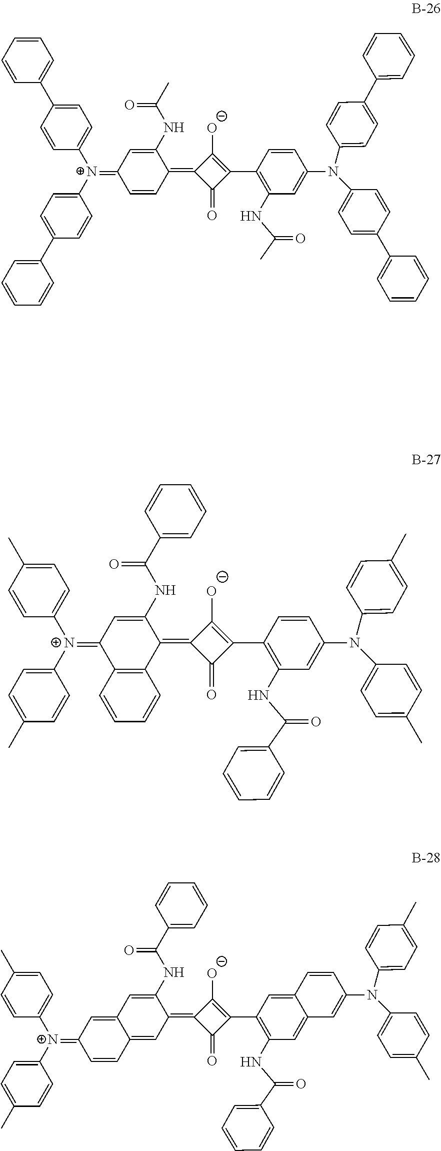

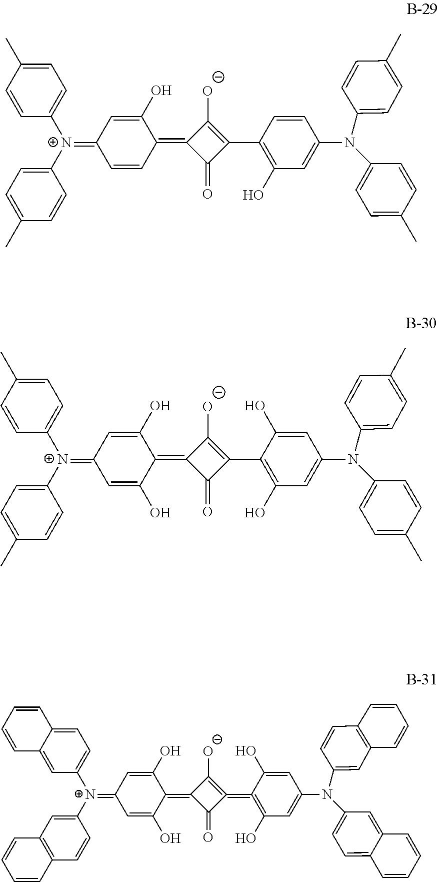

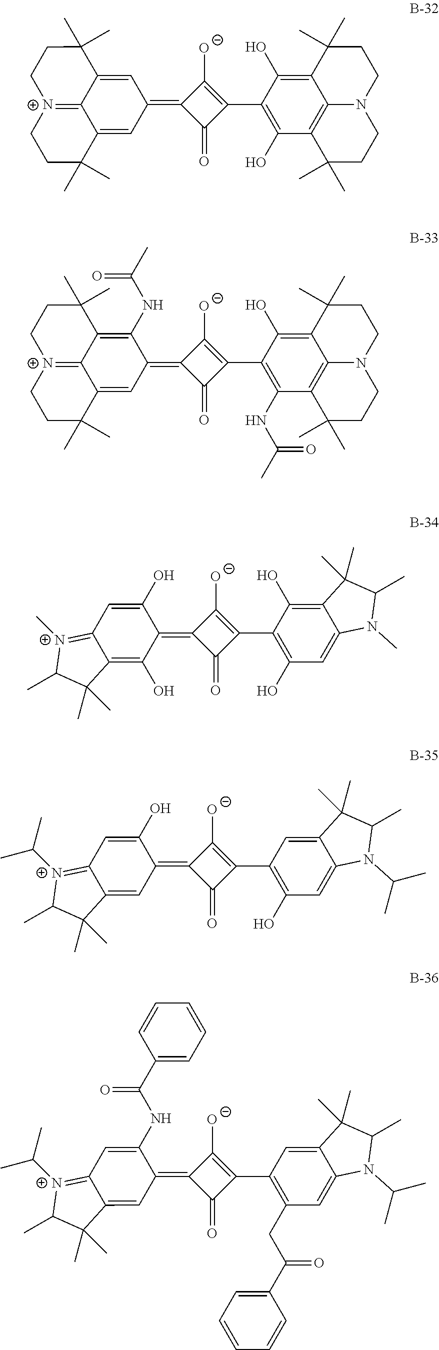

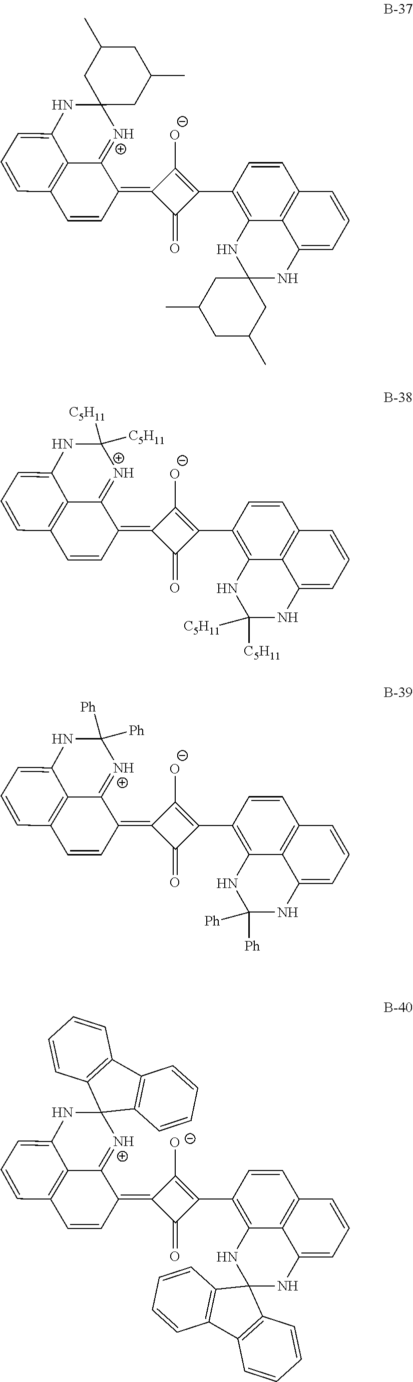

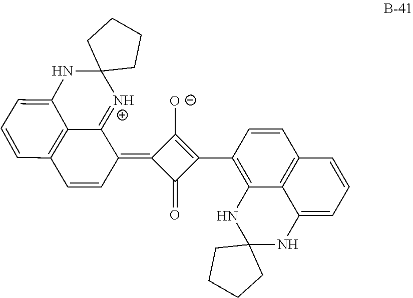 [SMILES: O=C1C(c2ccc3cccc4c3c2NC2(CCCC2)N4)=C([O-])/C1=c1/ccc2cccc3c2c1=[NH+]C1(CCCC1)N3]

Among the above compounds, Specific Examples B-1, B-3, B-4, B-6, B-9, B-11, B-21, B-24, B-30, B-31, B-37, B-38, B-40, and B-41 are more preferable compounds.

### Polymerization Inhibitor

The ink according to the present disclosure may include at least one polymerization inhibitor.

Examples of the polymerization inhibitor include p-methoxyphenol, quinones (e.g., hydroquinone, benzoquinone, and methoxybenzoquinone), phenothiazine, catechols, alkylphenols (e.g., dibutyl hydroxy toluene (BHT)), alkylbisphenols, zinc dimethyldithiocarbamate, copper dimethyldithiocarbamate, copper dibutyldithiocarbamate, copper salicylate, thiodipropionic acid esters, mercaptobenzimidazole, phosphites, 2,2,6,6-tetramethylpiperidine 1-oxyl (TEMPO), 2,2,6,6-tetramethyl-4-hydroxypiperidine 1-oxyl (TEMPOL), and tris(N-nitroso-N-phenylhydroxylamine) aluminum salt (also called as “Cupferron A1”).

Among these, at least one selected from p-methoxyphenol, catechols, quinones, alkylphenols, TEMPO, TEMPOL, and tris(N-nitroso-N-phenylhydroxylamine) aluminum salt is preferable, and at least one selected from p-methoxyphenol, hydroquinone, benzoquinone, BHT, TEMPO, TEMPOL, and tris(N-nitroso-N-phenylhydroxylamine) aluminum salt is more preferable.

In the case where the ink according to the present disclosure includes the polymerization inhibitor, the content of the polymerization inhibitor in the ink is preferably 0.01% to 2.0% by mass, is more preferably 0.02% to 1.0% by mass, and is particularly preferably 0.03% to 0.5% by mass of the total amount of the ink.

### Surfactant

The ink according to the present disclosure may include a surfactant but does not necessarily include a surfactant substantially.

Specifically, the content of the surfactant in the ink according to the present disclosure may be 0.01% by mass or less, may be 0.0001% by mass or less, and may be 0% by mass of the total amount of the ink.

### Organic Solvent

The ink according to the present disclosure may contain a trace amount of organic solvent such that the above-described advantageous effects are not impaired.

However, it is preferable that the ink according to the present disclosure do not include an organic solvent or, when the ink includes an organic solvent, the content of the organic solvent be minimized in order to reduce negative impacts to recording media.

In order to further reduce negative impacts to recording media, the content of the organic solvent in the ink is preferably less than 5% by mass, is more preferably less than 3% by mass, and is further preferably less than 1% by mass of the total amount of the ink.

### Water

The ink according to the present disclosure may include a trace amount of water such that the above-described advantageous effects are not impaired.

However, it is preferable that the ink according to the present disclosure do not include water or, when the ink includes water, the content of water be minimized in order to achieve the above-described advantageous effects with further effect.

The content of water in the ink is preferably less than 5% by mass, is more preferably less than 3% by mass, and is further preferably less than 1% by mass of the total amount of the ink.

### Cation Polymerizable Monomer

The ink according to the present disclosure may include a cation polymerizable monomer such that the above-described advantageous effects are not impaired.

Examples of the cation polymerizable monomer include a compound having an oxetane ring and an epoxy compound. These compounds are described in, for example, JP2006-152064A.

However, it is preferable that the ink according to the present disclosure do not include the cation polymerizable monomer or, when the ink includes the cation polymerizable monomer, the content of the cation polymerizable monomer be minimized in order to achieve the above-described advantageous effects with further effect.

The content of the cation polymerizable monomer in the ink is preferably less than 5% by mass, is more preferably less than 3% by mass, and is further preferably less than 1% by mass of the total amount of the ink.

### Other Constituent

The ink according to the present disclosure may include a constituent other than any of the above-described constituents.

Examples of the other constituent include an antimicrobial agent and a resin, such as a polyester resin, a polyurethane resin, a vinyl resin, an acrylic resin, or a rubber resin.

### Ink Jet Ink

The ink according to the present disclosure is preferably an ink jet ink.

In the case where the ink according to the present disclosure is an ink jet ink, the preferable physical properties of the ink are as described below.

The surface tension of the ink according to the present disclosure (specifically, at 25° C.) is preferably 20 to 50 mN/m and is more preferably 28 to 50 mN/m.

When the surface tension of the ink is 20 mN/m or more, the ink discharge performance is further enhanced.

When the surface tension of the ink is 50 mN/m or less, the quality of the image is further enhanced.

The viscosity of the ink according to the present disclosure at 25° C. is preferably 10 to 50 m·Pas, is more preferably 10 to 30 m·Pas, and is further preferably 10 to 25 m·Pas. The viscosity of the ink can be adjusted by, for example, changing the compositional ratio of the constituents of the ink.

The term “viscosity” used herein refers to a value measured with a viscometer. Examples of the viscometer include “VISCOMETER RE-85L” produced by Toki Sangyo Co., Ltd.

When the viscosity of the ink falls within the above preferable range, discharge stability can be further enhanced.

### Image Recording Method

An image recording method according to the present disclosure includes

a step of applying the ink according to the present disclosure to a recording medium to form an ink film (hereinafter, this step is also referred to as “first application step”) and

a step of irradiating the ink film with an active energy ray (hereinafter, this step is also referred to as “first irradiation step”).

The image recording method according to the present disclosure may further include another step as needed.

As described above, in the image recording method according to the present disclosure, the ink according to the present disclosure is used. Therefore, the image recording method according to the present disclosure may produce the same advantages effects as the ink according to the present disclosure.

### Recording Medium

A recording medium used in the image recording method according to the present disclosure is not limited.

Examples of the recording medium include a paper sheet; a paper sheet laminated with a plastic, such as polyethylene, polypropylene, or polystyrene; a metal sheet (e.g., a sheet made of a metal, such as aluminum, zinc, or copper); a plastic film (e.g., a film made of a plastic, such as a polyvinyl chloride (PVC) resin, cellulose diacetate, cellulose triacetate, cellulose propionate, cellulose butyrate, cellulose acetate butyrate, cellulose nitrate, polyethylene terephthalate (PET), polyethylene (PE), polystyrene (PS), polypropylene (PP), polycarbonate (PC), polyvinyl acetal, or an acrylic resin); a paper sheet on which a film made of any of the above metals is formed by lamination or vapor deposition; and a plastic film on which a film made of any of the above metals is formed by lamination or vapor deposition.

### First Application Step

In the first application step, the ink according to the present disclosure is applied to the recording medium to faun an ink film.

Examples of the method for application of the ink include common application methods known in the related art, such as a coating method, an ink jet method, and a dipping method.

An ink jet method is preferable as a method for application of the ink. In other words, the ink according to the present disclosure is preferably an ink jet ink.

An ink jet method is advantageous in that it does not require a printing plate and is capable of ejecting required amounts of ink droplets to intended positions on the basis of only an digital image.

For applying the ink to a recording medium by an ink jet method, a common application method known in the related art in which the ink is discharged from nozzles (i.e., discharge holes) of an ink jet head and applied to a recording medium can be used with an ink jet recording apparatus.

The ink jet recording apparatus is not limited. A common ink jet recording apparatus known in the related art which is capable of achieving the intended resolution can be selected and used appropriately. That is, common ink jet recording apparatuses known in the related art, which include commercial ink jet recording apparatuses, may be used.

Examples of the ink jet recording apparatus include an apparatus that includes an ink feed system, a temperature sensor, and a heating unit.

The ink feed system is constituted by, for example, a source tank that accommodates an ink, a feed pipe, an ink feed tank disposed immediately before an ink jet head, a filter, and a piezoelectric ink jet head. The piezoelectric ink jet head can be driven to discharge multi-size dots preferably having a volume of 1 to 100 pL and more preferably having a volume of 1 to 60 pL preferably at a resolution of 320 dpi×320 dpi (dot per inch) to 4,000 dpi×4,000 dpi (dot per inch), more preferably at 400 dpi×400 dpi to 1,600 dpi×1,600 dpi, and further preferably at 720 dpi×720 dpi to 1,600 dpi×1,600 dpi.

Note that “dpi” refers to the number of dots per inch (2.54 cm).

The volume of one droplet discharged from each of the nozzles of the ink jet head varies depending on the intended image resolution and is preferably 0.5 to 10 pL and is more preferably 0.5 to 2.5 pL in order to form a high-definition image.

The ink application system used in the ink jet method may be either a single pass system or a scan system and is preferably a single pass system in consideration of the speed at which an image is recorded.

In an image recording in which an ink other than the ink according to the present disclosure is applied by a single pass system, the resulting image is likely to have a significantly high gloss. However, in the case where an image is recorded using the ink according to the present disclosure, the gloss of the image can be effectively reduced even when the ink is applied by a single pass system.

Note that a single pass system is a system in which a line head including nozzles arranged to cover the entirety of a side of a recording medium is used as an ink jet head and fixed in position and, while the recording medium is transported in a direction perpendicular to the direction in which the nozzles of the line head are arranged, an ink is applied to the recording medium.

A scan system is a system in which a short serial head is used as an ink jet head and an ink is applied to a recording medium with the short serial head being driven to scan the recording medium.

The speed at which the recording medium is transported is preferably 1 to 120 m/s and is more preferably 50 m/s to 120 m/min.

Note that the preferable range of the speed at which a recording medium is transported in the second or later step is the same as the preferable range of the speed at which a recording medium is transported in the first step.

In the image recording method according to the present disclosure, the speed at which a recording medium is transported may be set to constant throughout all the steps or may be changed in at least some of the steps.

First Irradiation Step

In the first irradiation step, the ink film formed in the first application step is irradiated with an active energy ray.

In the first irradiation step, the irradiation of the ink film with an active energy ray causes at least a part of the radical polymerizable monomers included in the ink film to polymerize and thereby forms an image.

In the case where only a part of the radical polymerizable monomers included in the ink film is polymerized in the first irradiation step, the amount of irradiation energy of the active energy ray is reduced compared with the case where substantially the entirety of the radical polymerizable monomers included in the ink film is polymerized.

In the present disclosure, polymerizing only a part of the radical polymerizable monomers included in the ink film is referred to as “partial curing”, and irradiating the ink film with an active energy ray to perform partial curing is referred to as “pinning exposure”. In the present disclosure, polymerizing substantially the entirety of the radical polymerizable monomers included in the ink film is referred to as “full curing”, and irradiating the ink film with an active energy ray to perform full curing is referred to as “full exposure”.

The first irradiation step may be

a step of performing pinning exposure (i.e., partial curing) of the ink film,

a step of performing full exposure (i.e., full curing) of the ink film, or

a step of performing pinning exposure of the ink film and subsequently performing full exposure of the ink film.

In the case where the first irradiation step is a step of performing pinning exposure (i.e., partial curing) of the ink film, an image that is a partially cured ink film is formed in the first irradiation step.

In the case where the first irradiation step is a step of performing full exposure (i.e., full curing) of the ink film or a step of performing pinning exposure and full exposure of the ink film in this order, an image that is a fully cured ink film is formed in the first irradiation step.

In the case where the first irradiation step is a step of performing pinning exposure (i.e., partial curing) of the ink film, the image recording method preferably includes the second application step and second irradiation step described below.

The reaction rate of the ink film subsequent to the pinning exposure (i.e., partial curing) is preferably 10% to 80%.

Note that the term “reaction rate” of the ink film used herein refers to the rate of polymerization of the radical polymerizable monomers included in the ink film which is determined by high-performance liquid chromatography.

When the reaction rate of the ink film is 10% or more, the possibility of dots of the ink that is to be applied to the ink film (e.g., the second ink described below) failing to spread to a sufficient degree is reduced and, consequently, the final image (e.g., the secondary or higher color image described below) may be improved in terms of graininess (i.e., the graininess of the image is reduced).

When the reaction rate of the ink film is 80% or less, the possibility of dots of the ink that is to be applied to the ink film (e.g., the second ink described below) spreading to an excessive degree is reduced and the droplet interference between the ink dots is reduced. This enhances the quality of the final image.

The reaction rate of the ink film is preferably 15% or more in order to further improve the final image in terms of graininess.

The reaction rate of the ink film is preferably 75% or less, is more preferably 50% or less, is preferably 40% or less, is more preferably 30% or less, and is further preferably 25% or less in order to further enhance the quality of the final image.

The reaction rate of the ink film subsequent to the full exposure (i.e., full curing) is preferably more than 80% and 100% or less, is more preferably 85% to 100%, and is further preferably 90% to 100%.

When the above reaction rate is more than 80%, the adhesiveness of the image is further enhanced.

The reaction rate of the ink film is determined by the following method.

A recording medium including an ink film formed thereon, the ink film having been irradiated with an active energy ray, is prepared. A sample piece having a size of 20 mm×50 mm is taken from a region of the recording medium in which the ink film is present (hereinafter, this sample piece is referred to as “irradiated sample piece”). The irradiated sample piece is immersed in 10 mL of tetrahydrofuran (THF) for 24 hours in order to prepare a solution containing an eluted ink. This solution is subjected to high-performance liquid chromatography in order to measure the amount of radical polymerizable monomers (hereinafter, this amount is referred to as “amount of monomers X1 after irradiation”).

Subsequently, the same operation as described above is performed, except that the ink film disposed on a recording medium is not irradiated with an active energy ray and the amount of radical polymerizable monomers is measured (hereinafter, this amount is referred to as “amount of monomers X1 before irradiation”).

The ink reaction rate (%) is calculated using the following formula on the basis of the amount of monomers X1 after irradiation and the amount of monomers X1 before irradiation.

Ink reaction rate (%)=((Amount of monomers X1 before irradiation−Amount of monomers X1 after irradiation)/Amount of monomers X1 before irradiation)×100

The active energy ray used in the irradiation step (i.e., the active energy ray used for pinning exposure and/or full exposure; the same applies hereinafter) is preferably ultraviolet (UV) light and is more preferably UV light having a maximum illuminance at wavelengths of 385 to 410 nm.

A common UV light source known in the related art which is capable of changing at least one of illuminance or irradiation time can be used as a UV light source (i.e., source of UV light).

The UV light source is preferably a light-emitting diode (LED) light source.

The irradiation with an active energy ray in the irradiation step may be performed in an environment having an oxygen concentration of 20% by volume or less (more preferably less than 20% by volume and further preferably 5% by volume or less). In such a case, the possibility of the polymerization reaction being inhibited by oxygen is reduced and, consequently, an image having further high adhesiveness to recording media can be formed.

The environment having an oxygen concentration of less than 20% by volume is preferably an atmosphere containing an inert gas, such as a nitrogen gas, an argon gas, or a helium gas.

The illuminance of the active energy ray used for the pinning exposure is preferably 0.10 to 0.50 W/cm, is more preferably 0.20 to 0.49 W/cm, and is further preferably 0.20 to 0.45 W/cm in order to achieve the above-described ink reaction rate with further ease.

The amount of irradiation energy of the active energy ray used for the pinning exposure (hereinafter, this amount is also referred to as “amount of exposure”) is preferably 2 to 20 mJ/cm² and is more preferably 4 to 15 mJ/cm² in order to achieve the above-described ink reaction rate with further ease.

The illuminance of the active energy ray used for the full exposure is preferably 1.0 W/cm or more, is more preferably 2.0 W/cm or more, and is further preferably 4.0 W/cm or more in order to further enhance the adhesiveness of the image to a recording medium.

The upper limit for the illuminance of the active energy ray used for the full exposure is not set and is, for example, 10 W/cm.

The amount of irradiation energy of the active energy ray used for the full exposure (hereinafter, this amount is also referred to as “amount of exposure”) is preferably 20 mJ/cm² or more and is more preferably 80 mJ/cm² or more in order to further enhance the adhesiveness of the image to a recording medium.

The upper limit for the amount of irradiation energy of the active energy ray used for the full exposure is not set and is, for example, 240 mJ/cm².

### Second Application Step

The image recording method according to the present disclosure may include a second application step of applying a second ink to the ink film that has been irradiated with an active energy ray in the first irradiation step (hereinafter, also referred to as “first ink film”) to form a second ink film in contact with the first ink film.

The second ink is preferably an active energy ray-curable ink that includes a radical polymerizable monomer and a photopolymerization initiator and is more preferably the ink according to the present disclosure.

The number of the types of the second inks used in the second application step may be only one or two or more.

It is preferable that the ink according to the present disclosure used in the first application step (hereinafter, this ink is also referred to as “first ink”) and the second ink have different hues.

In the case where the first and second inks have different hues, a secondary or higher color image (e.g., secondary color image) can be recorded.

In the second application step, the second ink may be applied to both of the first ink film and a region of a recording medium in which the first ink film is absent.

In the second application step, it is sufficient that the second ink be applied to at least a part of the first ink film; the second ink is not necessarily applied to the entirety of the first ink film.

The method for the application of the second ink is the same as the method for the application of the first ink. The same applies to the preferable aspect.

The image recording method according to an aspect of the present disclosure which includes the second application step is capable of recording a secondary or higher color image having a reduced gloss.

### Second Irradiation Step

An image recording method according to an aspect of the present disclosure which includes the second application step may further include a second irradiation step of irradiating the entirety of the first and second ink films with a second active energy ray.

The second irradiation step may be

a step of performing pinning exposure (i.e., partial curing) of the entirety of the first and second ink films,

a step of performing full exposure (i.e., full curing) of the entirety of the first and second ink films, or

a step of performing pinning exposure and full exposure of the entirety of the first and second ink films in this order.

The preferable aspect of the second active energy ray and the preferable conditions for irradiation with the second active energy ray are the same as the preferable aspect of the active energy ray used in the first irradiation step and the preferable conditions for irradiation with the active energy ray in the first irradiation step.

For example, the preferable irradiation conditions under which the pinning exposure and full exposure are performed in the second irradiation step are the same as the preferable irradiation conditions under which the pinning exposure and full exposure are performed in the first irradiation step.

### EXAMPLES

Examples of the present disclosure are described below. Note that the present disclosure is not limited by Examples below.

Hereinafter, “parts” and “%” are on a mass basis unless otherwise specified.

### Preparation of Pigment Dispersions

As pigment dispersions used for preparing inks, a magenta pigment mill base (hereinafter, also referred to as “M pigment mill base”) and a squarylium pigment mill base (hereinafter, also referred to as “SQ pigment mill base”) were prepared.

Specifically, the constituents of each of the pigment mill bases were charged into a disperser “Motor Mill M50” produced by Eiger and dispersed using zirconia beads having a diameter of 0.65 mm at a rotation speed of 9 m/s for 8 hours to prepare a pigment mill base.

### Composition of M Pigment Mill Base

M (magenta) pigment: “CINQUASIA MAGENTA RT-355D” produced by BASF SE Japan: 30 parts by mass
“SR9003” produced by Sartomer (propoxylated (2) neopentyl glycol diacrylate used as a PO-modified neopentyl glycol diacrylate): 50 parts by mass
“SOLSPERSE 32000” produced by Lubrizol (amine dispersing agent): 20 parts by mass

### Composition of SQ Pigment Mill Base

SQ (squarylium) pigment: a pigment corresponding to Specific Example B-1 of the squarylium colorant above: 30 parts by mass
“SR9003” produced by Sartomer (propoxylated (2) neopentyl glycol diacrylate used as a PO-modified neopentyl glycol diacrylate): 50 parts by mass
“SOLSPERSE 35000” produced by Lubrizol (amine dispersing agent): 20 parts by mass

### Preparation of Inks

Inks for Examples and Inks for Comparative Examples having the compositions described in Tables 1 to 5 were each prepared by mixing the constituents described in Tables 1 to 5 with one another.

### Preparation of Image Recording Apparatus

An image recording apparatus (specifically, ink jet recording apparatus) that included a transport system that transports a recording medium; and a head for black ink, an ultraviolet (UV) light source, a head for cyan ink, an UV light source, a head for magenta ink, an UV light source, a head for yellow ink, an UV light source, a head for white ink, and a nitrogen purge UV exposure machine that were arranged in order from the upstream side in the direction in which a recording medium is transported was prepared. The transport system was a single-pass transport system of a sheet-fed printing press.

The heads for black, cyan, magenta, and yellow inks were piezoelectric ink jet heads (specifically, line heads) including ink jet nozzles (hereinafter, referred to simply as “nozzles”). Each of the nozzles was capable of ejecting multi-size dots having a volume of 1 to 60 pL at a resolution of 1,200 dpi×1,200 dpi. Note that “dpi” refers to the number of dots per inch (2.54 cm).

The ink feed system of the ink jet recording apparatus was constituted by a source tank, feed pipes, ink feed tanks disposed immediately before the ink jet heads, filters, and the ink jet heads. In the image recording performed in Examples, a portion of the ink feed system which extended from the ink feed tank to the ink jet head was thermally insulated and heated. Furthermore, a temperature sensor was disposed in the vicinity of each of the ink feed tanks and the nozzles of the ink jet heads and a temperature control was performed such that the temperatures of the nozzle portions were always 70° C.±2° C. Note that, in the examples where an ink including a gelling agent was used, a temperature control was performed such that the temperatures of the nozzle portions were always 90° C.±2° C.

One of the inks for Examples and the inks for Comparative Examples was charged into the source tank connected to the head for magenta ink.

The UV light source disposed immediately after each of the ink jet heads and the UV light source included in the nitrogen purge UV exposure machine were light-emitting diode (LED) lamps produced by KYOCERA Corporation (width: 4 cm, G4B, maximum illuminance: 10 W) capable of emitting UV light having a maximum illuminance at wavelengths of 385 to 410 nm.

The illuminance of UV light emitted from these UV light sources and the amount of irradiation time during which UV light was emitted from the UV light sources were changeable.

In the image recording performed in Examples, the speed at which a recording medium was transported was adjusted such that the irradiation of ink droplets discharged from the heads to the recording medium with UV light was started 0.1 seconds after the ink droplets have landed on the recording medium.

### Examples 1 to 41 and Comparative Examples 1 to 3

An image was recorded using one of the inks, the image recording apparatus, and a recording medium “OK Top Coat Paper” (84.9 g/m²) produced by Oji Paper Co., Ltd. in accordance with the above image recording method and evaluated in terms of the following items.

### Image Recording

The ink was applied to the recording medium in a solid pattern at a dot percent of 100% using the above image recording apparatus. The ink deposited on the recording medium was irradiated with UV light having an illuminance of 0.40 W/cm² for 0.024 seconds (pinning exposure) and subsequently irradiated with UV light having an illuminance of 5.0 W/cm² for 0.024 seconds (full exposure) to form an image (specifically, a solid image).

In this evaluation, pinning exposure was performed using a UV light source disposed immediately after the magenta ink head in an air atmosphere having an oxygen concentration of 20%.

Full exposure was performed using a nitrogen-purge UV exposing machine in an atmosphere having an oxygen concentration of 1% and a nitrogen concentration of 99%.

### Evaluations

The image and the ink were evaluated in term's of the following items.

Tables 1 to 5 list the results.

Reduction in Image Gloss

The glossiness of the recording medium on which the image had not been recorded and the glossiness of the image were measured with “High Gloss Checker IG-410” produced by HORIBA, Ltd. under 60° gloss conditions.

On the basis of the results, the difference obtained by subtracting the glossiness of the recording medium (i.e., the glossiness of the recording medium on which the image had not been recorded) from the glossiness of the image (hereinafter, this difference is referred to as “gloss difference [Image-Recording medium]”) was calculated. The reduction in image gloss was evaluated on the basis of the above results in accordance with the following evaluation criteria.

In the evaluation criteria below, an example that was the most excellent in terms of the effect to reduce the gloss of the image (i.e., the gloss of the image was most reduced) is rated as “5”.

Criteria for Evaluating Reduction in Image Gloss

5: The gloss difference [Image-Recording medium] was less than 20

4: The gloss difference [Image-Recording medium] was 20 or more and less than 25

3: The gloss difference [Image-Recording medium] was 25 or more and less than 30

2: The gloss difference [Image-Recording medium] was 30 or more and less than 40

1: The gloss difference [Image-Recording medium] was 40 or more

### Abrasion Resistance of Image

A paperweight having a weight of 150 g was placed on the image. In this state, a rubbing operation in which the paperweight was moved on the image in a reciprocating manner was performed repeatedly. A rubbing operation in which the paperweight made a round trip was considered as one cycle. In each of the stages in which the predetermined cycles of rubbing operation were completed, whether or not scratches were present on the image was determined. The abrasion resistance of the image was evaluated on the basis of the above results in accordance with the following evaluation criteria.

In the evaluation criteria below, an example that was the most excellent in terms of the abrasion resistance of the image is rated as “5”.

Note that, in Comparative Examples, this evaluation was omitted and “-” is shown in the column “Abrasion resistance” of Table 1.

Criteria for Evaluating Abrasion Resistance of Image

5: No scratches were present on the image in the stage in which 30 cycles of rubbing operation were completed.

4: Scratches were present on the image in the stage in which 30 cycles of rubbing operation were completed, but no scratches were present on the image in the stage in which 20 cycles of rubbing operation were completed.

3: Scratches were present on the image in the stage in which 20 cycles of rubbing operation were completed, but no scratches were present on the image in the stage in which 15 cycles of rubbing operation were completed.

2: Scratches were present on the image in the stage in which 15 cycles of rubbing operation were completed, but no scratches were present on the image in the stage in which 5 cycles of rubbing operation were completed.

1: Scratches were present on the image in the stage in which 5 cycles of rubbing operation were completed.

### Ink Discharge Performance

An evaluation in which the ink was continuously ejected from the magenta ink head of the image recording apparatus in a 1,200-dpi mode for 5 minutes and the number of misfiring nozzles that occurred in this operation was determined was made.

The above evaluation was made six times. The discharge performance of the ink was evaluated on the basis of the above results in accordance with the following evaluation criteria.

In the evaluation criteria below, an example that was the most excellent in terms of the discharge performance of the ink is rated as “5”.

Note that, in Comparative Examples, this evaluation was omitted and “-” is shown in the column “Discharge performance” of Table 1.

Criteria for Evaluating Discharge Performance of Ink

5: Misfiring nozzles did not occur in any of the six evaluations.

4: Only one misfiring nozzle occurred in one of the evaluations and misfiring nozzles did not occur in five evaluations.

3: Only one misfiring nozzle occurred in two evaluations and misfiring nozzles did not occur in four evaluations.

2: Only one misfiring nozzle occurred in three evaluations and misfiring nozzles did not occur in three evaluations.

1: At least one of the following was satisfied: only one misfiring nozzle occurred in four or more evaluations, or two or more misfiring nozzles occurred in one or more evaluations.

TABLE 1

| | | Comparative | Comparative | Comparative | | |
|---|---|---|---|---|---|---|
| | | Example | Example | Example | Example | Example |
| Ink | | 1 | 2 | 3 | 1 | 2 |
| Radical polymerizable | NVC (Monofunctional) | 10.0 | 15.0 | 15.0 | 15.0 | 15.0 |
| monomer (a) | IBOA (Monofunctional) | 30.0 | 22.0 | 17.0 | 5.0 | 5.0 |
| | TMPTA (Trifunctional) | 10.0 | 10.0 | 10.0 | 5.0 | 5.0 |
| | SR454 (Trifunctional) | 10.0 | 10.0 | 10.0 | 5.0 | 5.0 |
| | SR9003 (Difunctional) | 19.8 | 19.8 | 24.3 | 43.3 | 43.3 |
| Radical photopolymerization | TPO | 6.0 | 6.0 | 6.0 | 6.0 | |
| initiator (d) | 819 | | | | | 6.0 |
| Radical photosensitizer | ITX | 2.0 | 2.0 | 2.0 | 2.0 | |
| | Speedcure7010 | | | | | 2.0 |
| Polymerization inhibitor | UV-12 | 0.2 | 0.2 | 0.2 | 0.2 | 0.2 |
| Pigment dispersion | M pigment mill base | 12.0 | 12.0 | 12.0 | 12.0 | 12.0 |
| | SQ pigment mill base | | | | | |
| Inorganic oxide particles | KE-P50 (silica, particle size: 0.5 μm) | | 2.0 | | 2.0 | 2.0 |
| (b) | KE-P100 (silica, particle size: 1.0 μm) | | | | | |
| | KE-P150 (silica, particle size: 1.5 μm) | | | | | |
| | KE-P250 (silica, particle size: 2.5 μm) | | | | | |
| | QSG-170 (silica, particle size: 0.17 μm) | | | | | |
| | SMM-22 (alumina, particle size: 0.5 μm) | | | | | |
| Amine dispersing agent | Solsperse32000 | | 1.0 | | 1.0 | 1.0 |
| | DISPERBYK-108 | | | | | |
| | DISPERBYK-2008 | | | | | |
| Photoacid generator (c) | CPI-110P | | | 1.5 | 1.5 | 1.5 |
| | Omnicat 250 (solid content) | | | | | |
| Cation photosensitizer | UVS-1331 | | | 2.0 | 2.0 | 2.0 |
| Gelling agent | UNISTER M-2222SL | | | | | |
| | KAO WAX T1 | | | | | |
| | UNISTER H-476 | | | | | |

| | | | | | |
|---|---|---|---|---|---|
| (b)/(c) | — | — | 0.0 | 1.3 | 1.3 |
| (b) + (c) | 0 | 2.0 | 0.8 | 3.5 | 3.5 |
| ((a) + (b) + (c))/(d) | 14.3 | 14.1 | 13.8 | 13.8 | 13.8 |
| Monofunctional monomer + difunctional monomer | 65.8 | 62.8 | 62.3 | 69.3 | 69.3 |
| Gloss reduction | 1 | 1 | 1 | 5 | 5 |
| Abrasion resistance | — | — | — | 5 | 5 |
| Discharge performance | — | — | — | 5 | 5 |

| | | Example | Example | Example | Example |
|---|---|---|---|---|---|
| Ink | | 3 | 4 | 5 | 6 |
| Radical polymerizable | NVC (Monofunctional) | 15.0 | 15.0 | 15.0 | 15.0 |
| monomer (a) | IBOA (Monofunctional) | 5.0 | 5.0 | 5.0 | 5.0 |
| | TMPTA (Trifunctional) | 5.0 | 5.0 | 5.0 | 5.0 |
| | SR454 (Trifunctional) | 5.0 | 5.0 | 5.0 | 5.0 |
| | SR9003 (Difunctional) | 43.3 | 43.3 | 43.3 | 43.3 |
| Radical photopolymerization | TPO | 6.0 | 6.0 | 6.0 | 6.0 |
| initiator (d) | 819 | | | | |
| Radical photosensitizer | ITX | 2.0 | 2.0 | 2.0 | 2.0 |
| | Speedcure7010 | | | | |
| Polymerization inhibitor | UV-12 | 0.2 | 0.2 | 0.2 | 0.2 |
| Pigment dispersion | M pigment mill base | 12.0 | 12.0 | 12.0 | 12.0 |
| | SQ pigment mill base | | | | |
| Inorganic oxide particles | KE-P50 (silica, particle size: 0.5 μm) | | | | |
| (b) | KE-P100 (silica, particle size: 1.0 μm) | 2.0 | | | |
| | KE-P150 (silica, particle size: 1.5 μm) | | 2.0 | | |
| | KE-P250 (silica, particle size: 2.5 μm) | | | 2.0 | |
| | QSG-170 (silica, particle size: 0.17 μm) | | | | 2.0 |
| | SMM-22 (alumina, particle size: 0.5 μm) | | | | |
| Amine dispersing agent | Solsperse32000 | 1.0 | 1.0 | 1.0 | 1.0 |
| | DISPERBYK-108 | | | | |
| | DISPERBYK-2008 | | | | |
| Photoacid generator (c) | CPI-110P | 1.5 | 1.5 | 1.5 | 1.5 |
| | Omnicat 250 (solid content) | | | | |
| Cation photosensitizer | UVS-1331 | 2.0 | 2.0 | 2.0 | 2.0 |
| Gelling agent | UNISTER M-2222SL | | | | |
| | KAO WAX T1 | | | | |
| | UNISTER H-476 | | | | |

| | | | | |
|---|---|---|---|---|
| (b)/(c) | 1.3 | 1.3 | 1.3 | 1.3 |
| (b) + (c) | 3.5 | 3.5 | 3.5 | 3.5 |
| ((a) + (b) + (c))/(d) | 13.8 | 13.8 | 13.8 | 13.8 |
| Monofunctional monomer + difunctional monomer | 69.3 | 69.3 | 69.3 | 69.3 |
| Gloss reduction | 5 | 5 | 4 | 5 |
| Abrasion resistance | 5 | 5 | 5 | 5 |
| Discharge performance | 4 | 3 | 3 | 5 |

TABLE 2

| | | Example | Example | Example | Example | Example |
|---|---|---|---|---|---|---|
| Ink | | 7 | 8 | 9 | 10 | 11 |
| Radical polymerizable | NVC (Monofunctional) | 15.0 | 15.0 | 15.0 | 15.0 | 15.0 |
| monomer (a) | IBOA (Monofunctional) | 5.0 | 5.0 | 5.0 | 5.0 | 5.0 |
| | TMPTA (Trifunctional) | 5.0 | 5.0 | 5.0 | 5.0 | 5.0 |
| | SR454 (Trifunctional) | 5.0 | 5.0 | 5.0 | 5.0 | 5.0 |
| | SR9003 (Difunctional) | 43.3 | 43.3 | 43.3 | 43.3 | 43.3 |
| Radical photopolymerization | TPO | 6.0 | 6.0 | 6.0 | 6.0 | 6.0 |
| initiator (d) | 819 | | | | | |
| Radical photosensitizer | ITX | 2.0 | 2.0 | 2.0 | 2.0 | 2.0 |
| | Speedcure7010 | | | | | |
| Polymerization inhibitor | UV-12 | 0.2 | 0.2 | 0.2 | 0.2 | 0.2 |
| Pigment dispersion | M pigment mill base | 12.0 | 12.0 | 12.0 | 12.0 | 12.0 |
| | SQ pigment mill base | | | | | |
| Inorganic oxide particles | KE-P50 (silica, particle size: 0.5 μm) | | 1.0 | 2.0 | 2.0 | 2.0 |
| (b) | KE-P100 (silica, particle size: 1.0 μm) | | | | | |
| | KE-P150 (silica, particle size: 1.5 μm) | | | | | |
| | KE-P250 (silica, particle size: 2.5 μm) | | | | | |
| | QSG-170 (silica, particle size: 0.17 μm) | | | | | |
| | SMM-22 (alumina, particle size: 0.5 μm) | 2.0 | 1.0 | | | |
| Amine dispersing agent | Solsperse32000 | 1.0 | 1.0 | | | 1.0 |
| | DISPERBYK-108 | | | 1.0 | | |
| | DISPERBYK-2008 | | | | 1.0 | |
| Photoacid generator (c) | CPI-110P | 1.5 | 1.5 | 1.5 | 1.5 | |
| | Omnicat 250 (solid content) | | | | | 1.5 |
| Cation photosensitizer | UVS-1331 | 2.0 | 2.0 | 2.0 | 2.0 | 2.0 |
| Gelling agent | UNISTER M-2222SL | | | | | |
| | KAO WAX T1 | | | | | |
| | UNISTER H-476 | | | | | |

| | | | | | |
|---|---|---|---|---|---|
| (b)/(c) | 1.3 | 1.3 | 1.3 | 1.3 | 1.3 |
| (b) + (c) | 3.5 | 3.5 | 3.5 | 3.5 | 2.0 |
| ((a) + (b) + (c))/(d) | 13.8 | 13.8 | 13.8 | 13.8 | 13.6 |
| Monofunctional monomer + difunctional monomer | 69.3 | 69.3 | 69.3 | 69.3 | 69.3 |
| Gloss reduction | 5 | 5 | 5 | 5 | 4 |
| Abrasion resistance | 5 | 5 | 5 | 5 | 5 |
| Discharge performance | 5 | 5 | 5 | 5 | 5 |

| | | Example | Example | Example | Example |
|---|---|---|---|---|---|
| Ink | | 12 | 13 | 14 | 15 |
| Radical polymerizable | NVC (Monofunctional) | 15.0 | 15.0 | 15.0 | 15.0 |
| monomer (a) | IBOA (Monofunctional) | 5.0 | 5.0 | 5.0 | 5.0 |
| | TMPTA (Trifunctional) | 5.0 | 5.0 | 5.0 | 5.0 |
| | SR454 (Trifunctional) | 5.0 | 5.0 | 5.0 | 5.0 |
| | SR9003 (Difunctional) | 43.3 | 46.6 | 23.1 | 47.1 |
| Radical photopolymerization | TPO | 6.0 | 6.0 | 6.0 | 6.0 |
| initiator (d) | 819 | | | | |
| Radical photosensitizer | ITX | 2.0 | 2.0 | 2.0 | 2.0 |
| | Speedcure7010 | | | | |
| Polymerization inhibitor | UV-12 | 0.2 | 0.2 | 0.2 | 0.2 |
| Pigment dispersion | M pigment mill base | | 12.0 | 12.0 | 12.0 |
| | SQ pigment mill base | 12.0 | | | |
| Inorganic oxide particles | KE-P50 (silica, particle size: 0.5 μm) | 2.0 | 0.4 | 15.5 | 0.4 |
| (b) | KE-P100 (silica, particle size: 1.0 μm) | | | | |
| | KE-P150 (silica, particle size: 1.5 μm) | | | | |
| | KE-P250 (silica, particle size: 2.5 μm) | | | | |
| | QSG-170 (silica, particle size: 0.17 μm) | | | | |
| | SMM-22 (alumina, particle size: 0.5 μm) | | | | |
| Amine dispersing agent | Solsperse32000 | 1.0 | 0.2 | 7.8 | 0.2 |
| | DISPERBYK-108 | | | | |
| | DISPERBYK-2008 | | | | |
| Photoacid generator (c) | CPI-110P | 1.5 | 0.6 | 1.5 | 0.1 |
| | Omnicat 250 (solid content) | | | | |
| Cation photosensitizer | UVS-1331 | 2.0 | 2.0 | 2.0 | 2.0 |
| Gelling agent | UNISTER M-2222SL | | | | |
| | KAO WAX T1 | | | | |
| | UNISTER H-476 | | | | |

| | | | | |
|---|---|---|---|---|
| (b)/(c) | 1.3 | 0.7 | 10.3 | 4.0 |
| (b) + (c) | 3.5 | 1.0 | 17.0 | 0.5 |
| ((a) + (b) + (c))/(d) | 14.6 | 13.9 | 12.7 | 13.9 |
| Monofunctional monomer + difunctional monomer | 73.8 | 72.6 | 49.1 | 73.1 |
| Gloss reduction | 5 | 3 | 5 | 2 |
| Abrasion resistance | 5 | 4 | 4 | 3 |
| Discharge performance | 5 | 5 | 2 | 5 |

TABLE 3

| | | Example | Example | Example | Example | Example |
|---|---|---|---|---|---|---|
| Ink | | 16 | 17 | 18 | 19 | 20 |
| Radical polymerizable | NVC (Monofunctional) | 15.0 | 15.0 | 15.0 | 15.0 | 15.0 |
| monomer (a) | IBOA (Monofunctional) | 5.0 | 5.0 | 5.0 | 5.0 | 5.0 |
| | TMPTA (Trifunctional) | 5.0 | 5.0 | 5.0 | 5.0 | 5.0 |
| | SR454 (Trifunctional) | 5.0 | 5.0 | 5.0 | 5.0 | 5.0 |
| | SR9003 (Difunctional) | 46.4 | 45.6 | 44.9 | 36.2 | 33.4 |
| Radical photopolymerization | TPO | 6.0 | 6.0 | 6.0 | 6.0 | 6.0 |
| initiator (d) | 819 | | | | | |
| Radical photosensitizer | ITX | 2.0 | 2.0 | 2.0 | 2.0 | 2.0 |
| | Speedcure7010 | | | | | |
| Polymerization inhibitor | UV-12 | 0.2 | 0.2 | 0.2 | 0.2 | 0.2 |
| Pigment dispersion | M pigment mill base | 12.0 | 12.0 | 12.0 | 12.0 | 12.0 |
| | SQ pigment mill base | | | | | |
| Inorganic oxide particles | KE-P50 (silica, particle size: 0.5 μm) | 0.9 | 1.3 | 1.8 | 7.1 | 8.9 |
| (b) | KE-P100 (silica, particle size: 1.0 μm) | | | | | |
| | KE-P150 (silica, particle size: 1.5 μm) | | | | | |
| | KE-P250 (silica, particle size: 2.5 μm) | | | | | |
| | QSG-170 (silica, particle size: 0.17 μm) | | | | | |
| | SMM-22 (alumina, particle size: 0.5 μm) | | | | | |
| Amine dispersing agent | Solsperse32000 | 0.5 | 0.7 | 0.9 | 3.6 | 4.5 |
| | DISPERBYK-108 | | | | | |
| | DISPERBYK-2008 | | | | | |
| Photoacid generator (c) | CPI-110P | 0.1 | 0.2 | 0.2 | 0.9 | 1.1 |
| | Omnicat 250 (solid content) | | | | | |
| Cation photosensitizer | UVS-1331 | 2.0 | 2.0 | 2.0 | 2.0 | 2.0 |
| Gelling agent | UNISTER M-2222SL | | | | | |
| | KAO WAX T1 | | | | | |
| | UNISTER H-476 | | | | | |

| | | | | | |
|---|---|---|---|---|---|
| (b)/(c) | 9.0 | 6.5 | 9.0 | 7.9 | 8.1 |
| (b) + (c) | 1.0 | 1.5 | 2.0 | 8.0 | 10.0 |
| ((a) + (b) + (c))/(d) | 13.9 | 13.9 | 13.8 | 13.4 | 13.2 |
| Monofunctional monomer + difunctional monomer | 72.4 | 71.6 | 70.9 | 62.2 | 59.4 |
| Gloss reduction | 3 | 4 | 5 | 5 | 5 |
| Abrasion resistance | 4 | 5 | 5 | 5 | 5 |
| Discharge performance | 5 | 5 | 5 | 5 | 4 |

| | | Example | Example | Example | Example |
|---|---|---|---|---|---|
| Ink | | 21 | 22 | 23 | 24 |
| Radical polymerizable | NVC (Monofunctional) | 15.0 | 15.0 | 15.0 | 15.0 |
| monomer (a) | IBOA (Monofunctional) | 5.0 | 5.0 | 5.0 | 5.0 |
| | TMPTA (Trifunctional) | 5.0 | 5.0 | 5.0 | 5.0 |
| | SR454 (Trifunctional) | 5.0 | 5.0 | 5.0 | 5.0 |
| | SR9003 (Difunctional) | 26.1 | 18.9 | 32.1 | 31.6 |
| Radical photopolymerization | TPO | 6.0 | 6.0 | 6.0 | 6.0 |
| initiator (d) | 819 | | | | |
| Radical photosensitizer | ITX | 2.0 | 2.0 | 2.0 | 2.0 |
| | Speedcure7010 | | | | |
| Polymerization inhibitor | UV-12 | 0.2 | 0.2 | 0.2 | 0.2 |
| Pigment dispersion | M pigment mill base | 12.0 | 12.0 | 12.0 | 12.0 |
| | SQ pigment mill base | | | | |
| Inorganic oxide particles | KE-P50 (silica, particle size: 0.5 μm) | 13.3 | 17.8 | 1.4 | 2.5 |
| (b) | KE-P100 (silica, particle size: 1.0 μm) | | | | |
| | KE-P150 (silica, particle size: 1.5 μm) | | | | |
| | KE-P250 (silica, particle size: 2.5 μm) | | | | |
| | QSG-170 (silica, particle size: 0.17 μm) | | | | |
| | SMM-22 (alumina, particle size: 0.5 μm) | | | | |
| Amine dispersing agent | Solsperse32000 | 6.7 | 8.9 | 0.7 | 1.3 |
| | DISPERBYK-108 | | | | |
| | DISPERBYK-2008 | | | | |
| Photoacid generator (c) | CPI-110P | 1.7 | 2.2 | 13.6 | 12.5 |
| | Omnicat 250 (solid content) | | | | |
| Cation photosensitizer | UVS-1331 | 2.0 | 2.0 | 2.0 | 2.0 |
| Gelling agent | UNISTER M-2222SL | | | | |
| | KAO WAX T1 | | | | |
| | UNISTER H-476 | | | | |

| | | | | |
|---|---|---|---|---|
| (b)/(c) | 7.8 | 8.1 | 0.1 | 0.2 |
| (b) + (c) | 15.0 | 20.0 | 15.0 | 15.0 |
| ((a) + (b) + (c))/(d) | 12.9 | 12.5 | 13.9 | 13.8 |
| Monofunctional monomer + difunctional monomer | 52.1 | 44.9 | 58.1 | 57.6 |
| Gloss reduction | 4 | 4 | 2 | 2 |
| Abrasion resistance | 4 | 3 | 2 | 3 |
| Discharge performance | 3 | 2 | 3 | 3 |

TABLE 4

| | | Example | Example | Example | Example | Example |
|---|---|---|---|---|---|---|
| Ink | | 25 | 26 | 27 | 28 | 29 |
| Radical polymerizable | NVC (Monofunctional) | 15.0 | 15.0 | 15.0 | 15.0 | 15.0 |
| monomer (a) | IBOA (Monofunctional) | 5.0 | 5.0 | 5.0 | 5.0 | 5.0 |
| | TMPTA (Trifunctional) | 5.0 | 5.0 | 5.0 | 5.0 | 5.0 |
| | SR454 (Trifunctional) | 5.0 | 5.0 | 5.0 | 5.0 | 5.0 |
| | SR9003 (Difunctional) | 30.3 | 29.5 | 26.1 | 26.0 | 25.8 |
| Radical photopolymerization | TPO | 6.0 | 6.0 | 6.0 | 6.0 | 6.0 |
| initiator (d) | 819 | | | | | |
| Radical photosensitizer | ITX | 2.0 | 2.0 | 2.0 | 2.0 | 2.0 |
| | Speedcure7010 | | | | | |
| Polymerization inhibitor | UV-12 | 0.2 | 0.2 | 0.2 | 0.2 | 0.2 |
| Pigment dispersion | M pigment mill base | 12.0 | 12.0 | 12.0 | 12.0 | 12.0 |
| | SQ pigment mill base | | | | | |
| Inorganic oxide particles | KE-P50 (silica, particle size: 0.5 μm) | 5.0 | 6.7 | 13.3 | 13.6 | 14.0 |
| (b) | KE-P100 (silica, particle size: 1.0 μm) | | | | | |
| | KE-P150 (silica, particle size: 1.5 μm) | | | | | |
| | KE-P250 (silica, particle size: 2.5 μm) | | | | | |
| | QSG-170 (silica, particle size: 0.17 μm) | | | | | |
| | SMM-22 (alumina, particle size: 0.5 μm) | | | | | |
| Amine dispersing agent | Solsperse32000 | 2.5 | 3.4 | 6.7 | 6.8 | 7.0 |
| | DISPERBYK-108 | | | | | |
| | DISPERBYK-2008 | | | | | |
| Photoacid generator (c) | CPI-110P | 10.0 | 8.3 | 1.7 | 1.4 | 1.0 |
| | Omnicat 250 (solid content) | | | | | |
| Cation photosensitizer | UVS-1331 | 2.0 | 2.0 | 2.0 | 2.0 | 2.0 |
| Gelling agent | UNISTER M-2222SL | | | | | |
| | KAO WAX T1 | | | | | |
| | UNISTER H-476 | | | | | |

| | | | | | |
|---|---|---|---|---|---|
| (b)/(c) | 0.5 | 0.8 | 7.8 | 9.7 | 14.0 |
| (b) + (c) | 15.0 | 15.0 | 15.0 | 15.0 | 15.0 |
| ((a) + (b) + (c))/(d) | 13.6 | 13.4 | 12.9 | 12.8 | 12.8 |
| Monofunctional monomer + difunctional monomer | 56.3 | 55.5 | 52.1 | 52.0 | 51.8 |
| Gloss reduction | 3 | 4 | 4 | 3 | 3 |
| Abrasion resistance | 4 | 4 | 4 | 4 | 3 |
| Discharge performance | 3 | 3 | 3 | 3 | 3 |

| | | Example | Example | Example | Example |
|---|---|---|---|---|---|
| Ink | | 30 | 31 | 32 | 33 |
| Radical polymerizable | NVC (Monofunctional) | 15.0 | 15.0 | 15.0 | 15.0 |
| monomer (a) | IBOA (Monofunctional) | 5.0 | 5.0 | 5.0 | 5.0 |
| | TMPTA (Trifunctional) | 5.0 | 5.0 | 5.0 | 5.0 |
| | SR454 (Trifunctional) | 5.0 | 5.0 | 5.0 | 5.0 |
| | SR9003 (Difunctional) | 25.4 | 48.3 | 45.8 | 37.8 |
| Radical photopolymerization | TPO | 6.0 | 1.0 | 2.0 | 10.0 |
| initiator (d) | 819 | | | | |
| Radical photosensitizer | ITX | 2.0 | 2.0 | 2.0 | 2.0 |
| | Speedcure7010 | | | | |
| Polymerization inhibitor | UV-12 | 0.2 | 0.2 | 0.2 | 0.2 |
| Pigment dispersion | M pigment mill base | 12.0 | 12.0 | 12.0 | 12.0 |
| | SQ pigment mill base | | | | |
| Inorganic oxide particles | KE-P50 (silica, particle size: 0.5 μm) | 14.8 | 2.0 | 2.0 | 2.0 |
| (b) | KE-P100 (silica, particle size: 1.0 μm) | | | | |
| | KE-P150 (silica, particle size: 1.5 μm) | | | | |
| | KE-P250 (silica, particle size: 2.5 μm) | | | | |
| | QSG-170 (silica, particle size: 0.17 μm) | | | | |
| | SMM-22 (alumina, particle size: 0.5 μm) | | | | |
| Amine dispersing agent | Solsperse32000 | 7.4 | 1.0 | 1.0 | 1.0 |
| | DISPERBYK-108 | | | | |
| | DISPERBYK-2008 | | | | |
| Photoacid generator (c) | CPI-110P | 0.2 | 1.5 | 1.5 | 1.5 |
| | Omnicat 250 (solid content) | | | | |
| Cation photosensitizer | UVS-1331 | 2.0 | 2.0 | 2.0 | 2.0 |
| Gelling agent | UNISTER M-2222SL | | | | |
| | KAO WAX T1 | | | | |
| | UNISTER H-476 | | | | |

| | | | | |
|---|---|---|---|---|
| (b)/(c) | 74.0 | 1.3 | 1.3 | 1.3 |
| (b) + (c) | 15.0 | 3.5 | 3.5 | 3.5 |
| ((a) + (b) + (c))/(d) | 12.7 | 87.8 | 43.4 | 7.9 |
| Monofunctional monomer + difunctional monomer | 51.4 | 74.3 | 71.8 | 63.8 |
| Gloss reduction | 2 | 4 | 5 | 5 |
| Abrasion resistance | 3 | 3 | 3 | 4 |
| Discharge performance | 3 | 5 | 5 | 5 |

TABLE 5

| | | Example | Example | Example | Example | Example |
|---|---|---|---|---|---|---|
| Ink | | 34 | 35 | 36 | 37 | 38 |
| Radical polymerizable | NVC (Monofunctional) | 15.0 | 15.0 | 15.0 | 15.0 | 15.0 |
| monomer (a) | IBOA (Monofunctional) | 5.0 | 5.0 | 5.0 | 5.0 | 5.0 |
| | TMPTA (Trifunctional) | 5.0 | 5.0 | 5.0 | 5.0 | 5.0 |
| | SR454 (Trifunctional) | 5.0 | 5.0 | 5.0 | 5.0 | 5.0 |
| | SR9003 (Difunctional) | 33.8 | 43.8 | 42.8 | 39.8 | 37.8 |
| Radical photopolymerization | TPO | 14.0 | 6.0 | 6.0 | 6.0 | 6.0 |
| initiator (d) | 819.0 | | | | | |
| Radical photosensitizer | ITX | 2.0 | 2.0 | 2.0 | 2.0 | 2.0 |
| | Speedcure7010 | | | | | |
| Polymerization inhibitor | UV-12 | 0.2 | 0.2 | 0.2 | 0.2 | 0.2 |
| Pigment dispersion | M pigment mill base | 12.0 | 12.0 | 12.0 | 12.0 | 12.0 |
| | SQ pigment mill base | | | | | |
| Inorganic oxide particles | KE-P50 (silica, particle size: 0.5 μm) | 2.0 | 2.0 | 2.0 | 2.0 | 2.0 |
| (b) | KE-P100 (silica, particle size: 1.0 μm) | | | | | |
| | KE-P150 (silica, particle size: 1.5 μm) | | | | | |
| | KE-P250 (silica, particle size: 2.5 μm) | | | | | |
| | QSG-170 (silica, particle size: 0.17 μm) | | | | | |
| | SMM-22 (alumina, particle size: 0.5 μm) | | | | | |
| Amine dispersing agent | Solsperse32000 | 1.0 | 1.0 | 1.0 | 1.0 | 1.0 |
| | DISPERBYK-108 | | | | | |
| | DISPERBYK-2008 | | | | | |
| Photoacid generator (c) | CPI-110P | 1.5 | 1.5 | 1.5 | 1.5 | 1.5 |
| | Omnicat 250 (solid content) | | | | | |
| Cation photosensitizer | UVS-1331 | 2.0 | | 1.0 | 4.0 | 6.0 |
| Gelling agent | UNISTER M-2222SL | | | | | |
| | KAO WAX T1 | | | | | |
| | UNISTER H-476 | | | | | |

| | | | | | |
|---|---|---|---|---|---|
| (b)/(c) | 1.3 | 1.3 | 1.3 | 1.3 | 1.3 |
| (b) + (c) | 3.5 | 3.5 | 3.5 | 3.5 | 3.5 |
| ((a) + (b) + (c))/(d) | 5.3 | 14.1 | 14.0 | 13.5 | 13.1 |
| Monofunctional monomer + difunctional monomer | 59.8 | 69.8 | 68.8 | 65.8 | 63.8 |
| Gloss reduction | 5 | 4 | 5 | 5 | 5 |
| Abrasion resistance | 3 | 5 | 5 | 5 | 3 |
| Discharge performance | 5 | 5 | 5 | 5 | 5 |

| | | Example | Example | Example |
|---|---|---|---|---|
| Ink | | 39 | 40 | 41 |
| Radical polymerizable | NVC (Monofunctional) | 15.0 | 15.0 | 15.0 |
| monomer (a) | IBOA (Monofunctional) | 5.0 | 5.0 | 5.0 |
| | TMPTA (Trifunctional) | 5.0 | 5.0 | 5.0 |
| | SR454 (Trifunctional) | 5.0 | 5.0 | 5.0 |
| | SR9003 (Difunctional) | 39.1 | 39.1 | 39.1 |
| Radical photopolymerization | TPO | 6.0 | 6.0 | 6.0 |
| initiator (d) | 819.0 | | | |
| Radical photosensitizer | ITX | 2.0 | 2.0 | 2.0 |
| | Speedcure7010 | | | |
| Polymerization inhibitor | UV-12 | 0.2 | 0.2 | 0.2 |
| Pigment dispersion | M pigment mill base | 12.0 | 12.0 | 12.0 |
| | SQ pigment mill base | | | |
| Inorganic oxide particles | KE-P50 (silica, particle size: 0.5 μm) | 2.0 | 2.0 | 2.0 |
| (b) | KE-P100 (silica, particle size: 1.0 μm) | | | |
| | KE-P150 (silica, particle size: 1.5 μm) | | | |
| | KE-P250 (silica, particle size: 2.5 μm) | | | |
| | QSG-170 (silica, particle size: 0.17 μm) | | | |
| | SMM-22 (alumina, particle size: 0.5 μm) | | | |
| Amine dispersing agent | Solsperse32000 | 1.0 | 1.0 | 1.0 |
| | DISPERBYK-108 | | | |
| | DISPERBYK-2008 | | | |
| Photoacid generator (c) | CPI-110P | 1.5 | 1.5 | 1.5 |
| | Omnicat 250 (solid content) | | | |
| Cation photosensitizer | UVS-1331 | 2.0 | 2.0 | 2.0 |
| Gelling agent | UNISTER M-2222SL | 2.0 | | |
| | KAO WAX T1 | | 2.0 | |
| | UNISTER H-476 | | | 2.0 |

| | | | |
|---|---|---|---|
| (b)/(c) | 1.3 | 1.3 | 1.3 |
| (b) + (c) | 3.5 | 3.5 | 3.5 |
| ((a) + (b) + (c))/(d) | 13.5 | 13.5 | 13.5 |
| Monofunctional monomer + difunctional monomer | 65.1 | 65.1 | 65.1 |
| Gloss reduction | 5 | 5 | 5 |
| Abrasion resistance | 5 | 5 | 5 |
| Discharge performance | 5 | 5 | 5 |

### Description of Tables 1 to 5

The values in the columns of the constituents are the contents (% by mass) relative to the total amount of the ink. The blanks mean that the ink did not contain the constituents.

The symbol “(b)/(c)” means the mass ratio of the content of the inorganic oxide particles to the content of the photoacid generator.

The symbol “(b)+(c)” means the total content (% by mass) of the photoacid generator and the inorganic oxide particles relative to the total amount of the ink.

The symbol “((a)+(b)+(c))/(d)” means that the mass ratio of the total content of the radical polymerizable monomer, the inorganic oxide particles, and the photoacid generator to the content of the radical photopolymerization initiator.

The meanings of the abbreviations used for expressing radical polymerizable monomers are as follows.

NVC . . . N-vinyl caprolactam

IBOA . . . Isobornyl acrylate

TMPTA . . . Trimethylolpropane triacrylate

SR454 . . . SR454 produced by Sartomer, ethoxylated (3) trimethylolpropane triacrylate used as an EO-modified trimethylolpropane triacrylate

SR9003 . . . SR9003 produced by Sartomer, propoxylated (2) neopentyl glycol diacrylate used as a PO-modified neopentyl glycol diacrylate

Details of the radical photopolymerization initiator, the radical photosensitizer, the polymerization inhibitor, the inorganic oxide particles, the gelling agent, and the surfactant are as follows.

TPO . . . “Omnirad TPO” produced by IGM Resins B.V., 2,4,6-trimethylbenzoyldiphenylphosphine oxide

819 . . . “Omnirad 819” produced by IGM Resins B.V., bis(2,4,6-trimethylbenzoyl)phenylphosphine oxide

ITX . . . 2-isopropylthioxanthone

S7010 . . . “Speedcure 7010” produced by Lambson (high-molecular-weight radical photosensitizer, the compound name is as described above)

UV-12 . . . “FLORSTAB UV12” produced by Kromachem, nitroso polymerization inhibitor, tris(N-nitroso-N-phenylhydroxylamine) aluminum salt

KE-P50 . . . “Seahostar KE-P50” produced by Nippon Shokubai Co., Ltd. (silica particles, average primary particle size: 0.5 μm)

KE-P100 . . . “Seahostar KE-P100” produced by Nippon Shokubai Co., Ltd. (silica particles, average primary particle size: 1.0 μm)

KE-P150 . . . “Seahostar KE-P150” produced by Nippon Shokubai Co., Ltd. (silica particles, average primary particle size: 1.5 μm)

KE-P250 . . . “Seahostar KE-P250” produced by Nippon Shokubai Co., Ltd. (silica particles, average primary particle size: 2.5 μm)

QSG-170 . . . “QSG-170” produced by Shin-Etsu Chemical Co., Ltd. (silica particles, average primary particle size: 0.17 μm)

SMM-22 . . . “SMM-22” produced by Nippon Light Metal Company, Ltd. (alumina particles, average primary particle size: 0.5 μm)

SOLSPERSE 32000 . . . “SOLSPERSE 32000” produced by Lubrizol

DISPERBYK-108 . . . “DISPERBYK-108” produced by BYK Chemie

DISPERBYK-2008 . . . “DISPERBYK-2008” produced by BYK Chemie

CPI-110P . . . “CPI-110P” produced by San-Apro Ltd. (sulfonium salt (solid content): 100% by mass)

Omnicat 250 . . . “Omnicat 250” produced by IGM Resins B.V. (iodonium salt (solid content): 75% by mass)

UVS-1331 . . . “ANTHRACURE UVS-1331” produced by Kawasaki Kasei Chemicals (compound including an anthracene skeleton)

UNISTER M-2222SL . . . “UNISTER (registered trademark) M-2222SL” produced by NOF CORPORATION, behenyl behenate

KAO WAX T1 . . . “KAO WAX T1” produced by Kao Corporation, distearyl ketone

UNISTER H-476 . . . “UNISTER (registered trademark) H-476” produced by NOF CORPORATION, pentaerythritol tetrastearate

As listed in Tables 1 to 5, in Examples 1 to 41, where the ink included the radical polymerizable monomer, the inorganic oxide particles, the photoacid generator, and the radical photopolymerization initiator, the effect to reduce the gloss of the image was excellent.

In contrast, in Comparative Examples 1 and 3, where the ink did not include the inorganic oxide particles, and in Comparative Example 2, where the ink did not include the photoacid generator, the effect to reduce the gloss of the image was poor.

Among Examples 11 and 12, in Example 12, where the photoacid generator was a sulfonium salt, the effect to reduce the gloss of the image was more excellent.

Among Examples 35 and 36, in Example 36, where the ink included the cation photosensitizer, the effect to reduce the gloss of the image was more excellent.

Among Examples 36 to 38, in Examples 36 and 37, where the content of the cation photosensitizer was 5.0% by mass or less of the total amount of the ink, the abrasion resistance of the image was more excellent.

Among Examples 15 to 21, in Examples 16 to 21, where the content of the inorganic oxide particles was 0.5% by mass or more of the total amount of the ink, the effect to reduce the gloss of the image and the abrasion resistance of the image were more excellent.

Among Examples 16 to 22, in Examples 16 to 21, where the content of the inorganic oxide particles was 15.0% by mass or less of the total amount of the ink, the discharge performance of the ink and the abrasion resistance of the image were more excellent.

Among Examples 23 to 30, in Examples 24 to 29, where the mass ratio of the content of the inorganic oxide particles to the content of the photoacid generator (“(b)/(c)”) was 0.2 to 15.0, the effect to reduce the gloss of the image and the abrasion resistance of the image were more excellent.

Among Examples 15 to 21, in Examples 16 to 21, where the total content of the inorganic oxide particles and the photoacid generator relative to the total amount of the ink (“(b)+(c)”) was 1.0% by mass or more, the effect to reduce the gloss of the image and the abrasion resistance of the image were more excellent.

Among Examples 16 to 22, in Examples 16 to 21, where the total content (“(b)+(c)”) was 17.5% by mass or less, the discharge performance of the ink and the abrasion resistance of the image were more excellent.

Among Examples 31 to 34, in Examples 32 and 33, where the mass ratio of the total content of the radical polymerizable monomer, the inorganic oxide particles, and the photoacid generator to the content of the radical photopolymerization initiator (“((a)+(b)+(c))/(d)”) was 6.0 to 45.0, the effect to reduce the gloss of the image and the abrasion resistance of the image were more excellent.

Among Examples 21 and 22, in Example 21, where the radical polymerizable monomer included at least one of a monofunctional monomer or a difunctional monomer and the total content of the monofunctional monomer and the difunctional monomer was 50% by mass or more of the total amount of the ink, the discharge performance of the ink and the abrasion resistance of the image were more excellent.

It is needless to say that, although a magenta ink was used as an example of the ink according to the present disclosure and a squarylium pigment ink was used as an example of the invisible ink in Examples above, the advantageous effects that are the same as those produced in Examples above can be produced also in the case where an ink having a color other than magenta, an invisible ink other than a squarylium pigment ink, and a clear ink are used, as long as the conditions of the ink according to the present disclosure are satisfied.

It is also needless to say that the advantageous effects that are the same as those produced in Examples above can be produced also in the case where a multi-color image was recorded by forming a first-color ink film using the example of the ink according to the present disclosure, performing pinning exposure, then applying inks of second and latter colors that include a radical polymerizable monomer, a photopolymerization initiator, and a colorant such that the inks overlap at least a part of the first-color ink film to form ink films of the second and latter colors, and subjecting the first-color ink film and the ink films of the second and latter colors to the full exposure.

Japanese Patent Application No. 2020-056584 filed on Mar. 26, 2020, is incorporated herein by reference in its entirety.

All documents, patent applications, and technical standards referred to herein are incorporated herein by reference in their entirety to the same extent as when the individual documents, patent applications, and technical standards are specifically and individually indicated to be incorporated by reference in its entirety.

What is claimed is:

1. An active energy ray-curable ink, comprising:
a radical polymerizable monomer;
inorganic oxide particles;
a photoacid generator; and
a radical photopolymerization initiator,
wherein the inorganic oxide particles have an average primary particle size of 0.1 μm to 3.0 μm.

2. The active energy ray-curable ink according to claim 1,
wherein the inorganic oxide particles comprise at least one of silica particles or alumina particles.

3. The active energy ray-curable ink according to claim 1,
wherein the photoacid generator is a sulfonium salt.

4. The active energy ray-curable ink according to claim 1, further comprising:
a cation photosensitizer.

5. The active energy ray-curable ink according to claim 4,
wherein the cation photosensitizer is a compound having an anthracene skeleton.

6. The active energy ray-curable ink according to claim 4,
wherein a content of the cation photosensitizer is from 0.5% by mass to 5.0% by mass with respect to a total amount of the active energy ray-curable ink.

7. The active energy ray-curable ink according to claim 1,
wherein a content of the inorganic oxide particles is from 0.5% by mass to 15.0% by mass with respect to a total amount of the active energy ray-curable ink.

8. The active energy ray-curable ink according to claim 1,
wherein a mass ratio of a content of the inorganic oxide particles to a content of the photoacid generator is from 0.2 to 15.0.

9. The active energy ray-curable ink according to claim 1,
wherein a total content of the inorganic oxide particles and the photoacid generator is from 1.0% by mass to 17.5% by mass with respect to a total amount of the active energy ray-curable ink.

10. The active energy ray-curable ink according to claim 1,
wherein a mass ratio of a total content of the radical polymerizable monomer, the inorganic oxide particles, and the photoacid generator to a content of the radical photopolymerization initiator is from 6.0 to 45.0.

11. The active energy ray-curable ink according to claim 1,
wherein the radical polymerizable monomer comprises at least one of a monofunctional radical polymerizable monomer or a difunctional radical polymerizable monomer; and
wherein a total content of the monofunctional radical polymerizable monomer and the difunctional radical polymerizable monomer is 50% by mass or more with respect to a total amount of the active energy ray-curable ink.

12. The active energy ray-curable ink according to claim 1, further comprising:
a gelling agent that is at least one selected from the group consisting of an ester compound comprising a chain alkyl group having 12 or more carbon atoms and a ketone compound comprising a chain alkyl group having 12 or more carbon atoms.

13. An image recording method comprising:
applying the active energy ray-curable ink according to claim 1 to a recording medium to form an ink film; and
irradiating the ink film with an active energy ray.

14. The image recording method according to claim 13,
wherein the irradiating comprises irradiating the ink film with the active energy ray in an atmosphere having an oxygen concentration of 5% by volume or less.
